(19) United States
(12) Patent Application Publication
(10) Pub. No.: US 2019/0185782 A1
(43) Pub. Date: Jun. 20, 2019

(54) LUBRICATING OIL COMPOSITIONS CONTAINING MICROENCAPSULATED ADDITIVES

(71) Applicant: ExxonMobil Research and Engineering Company, Annandale, NJ (US)

(72) Inventors: Martin N. WEBSTER, Pennington, NJ (US); Anne Marie SHOUGH, Conroe, TX (US); James D. OXLEY, Helotes, TX (US); Jose L. MENDEZ, San Antonio, TX (US)

(21) Appl. No.: 16/188,757

(22) Filed: Nov. 13, 2018

Related U.S. Application Data
(60) Provisional application No. 62/599,134, filed on Dec. 15, 2017.

(51) Int. Cl. C10M 171/06; C10M 169/04; C10M 159/18; C08L 39/06; C08L 1/08

(52) U.S. Cl. CPC C10M 171/06; C10M 169/04; C10M 159/18; C08L 39/06; C08L 1/08; C10N 2210/06; C10N 2240/10; C10N 2220/082; C10N 2230/04; C10N 2230/10; C10N 2230/12; C10N 2230/06; C10N 2220/084

(57) ABSTRACT

A method for extending performance or service life of a lubricating oil in an engine or other mechanical component lubricated with the lubricating oil by using as the lubricating oil a formulated oil. The formulated oil has a composition including a lubricating oil base stock as a major component, and at least one microencapsulated lubricating oil additive, as a minor component. The at least one microencapsulated lubricating oil additive includes an encapsulating material (e.g., polymeric matrix) and a core material (e.g., at least one lubricating oil additive) encapsulated by the encapsulating material. A method of improving solubility, compatibility and/or dispersion of lubricating oil additives in a lubricating oil base stock. A method for controlling release of a lubricating oil additive into a lubricating oil. A lubricating oil having a composition including a lubricating oil base stock as a major component, and at least one microencapsulated lubricating oil additive, as a minor component.

### CROSS-REFERENCE TO RELATED APPLICATIONS

This application claims the benefit of U.S. Provisional Application No. 62/599,134, filed on Dec. 15, 2017, the entire contents of which are incorporated herein by reference.

### FIELD

This disclosure relates to lubricating oil compositions containing microencapsulated lubricating oil additives. Also, this disclosure relates to a method for extending performance of a lubricating oil in an engine or other mechanical component lubricated with the lubricating oil. Further, this disclosure relates to a method for controlling release of lubricating oil additives into a lubricating oil. Yet further, this disclosure relates to a method for improving solubility, compatibility and dispersion of lubricating oil additives in a lubricating oil.

### BACKGROUND

A major challenge in engine oil formulation is extending performance or service life of a lubricating oil in an engine or other mechanical component lubricated with the lubricating oil. Conventional lubricants contain additives in which the performance benefits of those additives degrade over the in-service life of the lubricating oil.

A lubricating oil lubricates moving components of an engine or other mechanical component lubricated with the lubricating oil. For example, an engine lubricating oil lubricates pistons that reciprocate in cylinders, a crankshaft that rotates on bearings, and a camshaft that drives intake and exhaust valves. Lubricating oils reduce friction between moving components, reduce wear and remove heat from engine or other mechanical components, and coat metal components to inhibit corrosion.

Additives are included in lubricating oils to increase performance of the oil. For example, lubricating oils can include antioxidant additives that prevent the oil from thickening, friction modifier additives that reduce friction thereby increasing fuel economy, or dispersant additives that hold contaminants in suspension. Also, lubricating oils can include antifoam additives that inhibit the production and retention of air bubbles on the surface and in the oil, and detergent additives that reduce deposits in an engine.

Currently, lubricating oil additive technology relies on the inherent solubility and stability of the molecular structure of a given performance additive within a given service environment to determine longevity of performance. Increasing longevity of lubricating oil performance or service life can decrease oil consumption and increase the time intervals between oil changes.

Despite advances in lubricant oil formulation technology, there exists a need for extending performance or service life of a lubricating oil in an engine or other mechanical component. In addition, there exists a need for an engine oil lubricant that effectively improves solubility, compatibility and dispersion of additives in a lubricating oil.

### SUMMARY

This disclosure relates to lubricating oil compositions containing microencapsulated lubricating oil additives. Also, this disclosure relates to a method for extending performance of a lubricating oil in an engine or other mechanical component lubricated with the lubricating oil. Further, this disclosure relates to a method for controlling release of lubricating oil additives into a lubricating oil. Still further, this disclosure relates to a method for improving solubility, compatibility and dispersion of lubricating oil additives in a lubricating oil.

This disclosure relates in part to a method for extending performance or service life of a lubricating oil in an engine or other mechanical component lubricated with the lubricating oil by using as the lubricating oil a formulated oil. The formulated oil has a composition comprising a lubricating oil base stock as a major component; and at least one microencapsulated lubricating oil additive, as a minor component. The at least one microencapsulated lubricating oil additive comprises an encapsulating material and a core material encapsulated by the encapsulating material. The encapsulating material comprises a polymeric matrix and the core material comprises at least one lubricating oil additive.

In an embodiment, duration of performance or service life of the lubricating oil in an engine or other mechanical component lubricated with the lubricating oil is extended as compared to duration of performance or service life of a lubricating oil containing a minor component other than the at least one microencapsulated lubricating oil additive.

This disclosure also relates in part to a method of improving solubility, compatibility and/or dispersion of lubricating oil additives in a lubricating oil base stock. The method comprises:

providing a lubricating oil base stock; and blending at least one microencapsulated lubricating oil additive in the lubricating oil base stock. The at least one microencapsulated lubricating oil additive comprises an encapsulating material and a core material encapsulated by the encapsulating material. The encapsulating material comprises a polymeric matrix and the core material comprises at least one lubricating oil additive.

In an embodiment, solubility, compatibility and/or dispersion of the lubricating oil additives in the lubricating oil base stock is improved as compared to solubility, compatibility and/or dispersion of lubricating oil additives in a lubricating oil base stock containing a minor component other than the at least one microencapsulated lubricating oil additive.

This disclosure further relates in part to a method for controlling release of a lubricating oil additive into a lubricating oil by using as the lubricating oil a formulated oil. The formulated oil has a composition comprising a lubricating oil base stock as a major component, and at least one microencapsulated lubricating oil additive, as a minor component. The at least one microencapsulated lubricating oil additive comprises an encapsulating material and a core material encapsulated by the encapsulating material. The encapsulating material comprises a polymeric matrix and the core material comprises at least one lubricating oil additive.

In an embodiment, release of the lubricating oil additive into the lubricating oil is slowed and controlled as compared to release of a lubricating oil additive into a lubricating oil containing a minor component other than the at least one microencapsulated lubricating oil additive.

This disclosure yet further relates in part to a lubricating oil having a composition comprising a lubricating oil base stock as a major component, and at least one microencapsulated lubricating oil additive, as a minor component. The at least one microencapsulated lubricating oil additive comprises an encapsulating material and a core material encapsulated by the encapsulating material. The encapsulating material comprises a polymeric matrix and the core material comprises at least one lubricating oil additive.

This disclosure also relates in part to a microcapsule comprising: an encapsulating material comprising a polymeric matrix; and a core material comprising at least one lubricating oil additive. The microcapsule has an average particle size d₅₀ from about 100 nanometers (nm) to about 1 micrometer (μm).

It has been surprisingly found that, in accordance with this disclosure, duration of performance of a lubricating oil in an engine or other mechanical component lubricated with the lubricating oil, is extended by including at least one microencapsulated lubricating oil additive in the lubricating oil. The at least one microencapsulated lubricating oil additive comprises an encapsulating material (i.e., polymeric matrix) and a core material (i.e., at least one lubricating oil additive) encapsulated by the encapsulating material. The use of microencapsulated lubricating oil additives surprisingly extends duration of performance (i.e., service life) of the lubricating oil.

Also, it has been surprisingly found that, in accordance with this disclosure, improvements in solubility, compatibility and/or disperson of lubricating oil additives in a lubricating oil base stock are obtained by including at least one microencapsulated lubricating oil additive in the lubricating oil. The at least one microencapsulated lubricating oil additive comprises an encapsulating material (i.e., polymeric matrix) and a core material (i.e., at least one lubricating oil additive) encapsulated by the encapsulating material. The use of microencapsulated lubricating oil additives surprisingly enables enhanced solubility, compatibility and/or dispersion of lubricating oil additives in a lubricating oil base stock.

Further, it has been surprisingly found that, in accordance with this disclosure, controlled release of lubricating oil additives into a lubricating oil base stock is achieved by including at least one microencapsulated lubricating oil additive in the lubricating oil. The at least one microencapsulated lubricating oil additive comprises an encapsulating material (i.e., polymeric matrix) and a core material (i.e., at least one lubricating oil additive) encapsulated by the encapsulating material. The use of microencapsulated lubricating oil additives surprisingly enables a controlled release of the lubricating oil additives over the service life of the lubricating oil.

Other objects and advantages of the present disclosure will become apparent from the detailed description that follows.

### BRIEF DESCRIPTION OF THE DRAWINGS

FIG. 1 graphically depicts thermal stability testing results of polymeric matrix microparticles containing a soluble molybdenum friction modifier. The filtrate was measured with inductively coupled plasma mass spectrometry (ICP-Mo) in accordance with the Examples.

FIG. 2 graphically depicts thermal stability testing results of polymeric matrix microparticles containing an organic friction modifier. FIG. 2 also shows thermal stability of polyurea core shell microparticles containing an organic friction modifier. The filtrate was measured with proton nuclear magnetic resonance (H-NMR) in accordance with the Examples.

FIG. 3 graphically depicts shear stability testing results of polymeric matrix microparticles containing a soluble molybdenum friction modifier. The filtrate was measured with inductively coupled plasma mass spectrometry (ICP-Mo) in accordance with the Examples.

FIG. 4 graphically depicts shear stability testing results of polymeric matrix microparticles containing an organic friction modifier. FIG. 4 also graphically depicts shear stability of polyurea core shell microparticles containing an organic friction modifier. The filtrate was measured with proton nuclear magnetic resonance (H-NMR) in accordance with the Examples.

FIG. 5 graphically depicts High Frequency Reciprocating Rig (HFRR) testing results (i.e., friction response) of a soluble molybdenum friction modifier in bulk form as compared to encapsulated in hydroxypropyl cellulose (HPC) polymeric matrix or polyvinyl pyrrolidone (PVP) polymeric matrix in accordance with the Examples.

FIG. 6 graphically depicts HFRR testing results (i.e., friction response) of an organic friction modifier in bulk form as compared to encapsulated in hydroxypropyl cellulose (HPC) polymeric matrix, polyvinyl pyrrolidone (PVP) polymeric matrix, ethyl cellulose (EC) polymeric matrix, or polyurea core shell capsule in accordance with the Examples.

FIG. 7 shows an SEM image of an organic friction modifier that has been encapsulated polyvinyl pyrrolidone (PVP) polymer matrix. In this case the majority of the spherical capsules are less than 1 micron in diameter.

FIG. 8 shows the results of a finite element analysis of how a PVP/organic friction modifier capsule will deform as it passes through the narrow gap formed between two lubricated surfaces. The results show that much of the capsule will undergo permanent deformation and is likely to rupture.

FIG. 9 shows an SEM image of PVP/organic friction modifier capsules that have been run in a rolling element bearing test for 20 hours. The deformed and ruptured capsules are consistent with the finite element results and indicate that the capsules will release the organic friction modifier into the lubricant as they pass through a lubricated contact.

### DETAILED DESCRIPTION

All numerical values within the detailed description and the claims herein are modified by “about” or “approximately” the indicated value, and take into account experimental error and variations that would be expected by a person having ordinary skill in the art. The phrase “major amount” or “major component” as it relates to components included within the lubricating oils of the specification and the claims means greater than or equal to 50 wt. %, or greater than or equal to 60 wt. %, or greater than or equal to 70 wt. %, or greater than or equal to 80 wt. %, or greater than or equal to 90 wt. % based on the total weight of the lubricating oil. The phrase “minor amount” or “minor component” as it relates to components included within the lubricating oils of the specification and the claims means less than 50 wt. %, or less than or equal to 40 wt. %, or less than or equal to 30 wt. %, or greater than or equal to 20 wt. %, or less than or equal to 10 wt. %, or less than or equal to 5 wt. %, or less than or equal to 2 wt. %, or less than or equal to 1 wt. %, based on the total weight of the lubricating oil. The phrase “essentially free” as it relates to components included within the lubricating oils of the specification and the claims means that the particular component is at 0 weight % within the lubricating oil, or alternatively is at impurity type levels within the lubricating oil (less than 100 ppm, or less than 20 ppm, or less than 10 ppm, or less than 1 ppm). The phrase “other lubricating oil additives” as used in the specification and the claims means other lubricating oil additives that are not specifically recited in the particular section of the specification or the claims. For example, other lubricating oil additives may include, but are not limited to, antioxidants, detergents, dispersants, antiwear additives, corrosion inhibitors, viscosity modifiers, metal passivators, pour point depressants, seal compatibility agents, antifoam agents, extreme pressure agents, friction modifiers and combinations thereof.

As used herein, “microencapsulated particles” refers to particles having an average particle size of less than about 5 microns, such as less than about 4 microns, less than about 3 microns, less than about 2 microns, or less than about 1 micron. Preferably, the material has an average particle size of less than about 1 micron, such as less than about 0.75 microns, less than about 0.5 microns, less than about 0.25 microns, or less than about 0.1 microns. In embodiments, the microencapsulated particles can range in average particle size, d₅₀, or average particle diameter as measured by TEM imaging, from about 0.01 microns to about 5 microns, such as from about 0.01 microns to about 2.5 microns, or from about 0.01 microns to about 1 micron. Microencapsulated particles include nanoscale particles.

The nanoscale particles have an average particle size of less than about 250 nm, such as about 100 nm to about 125, about 150, about 175, or about 200 nm. Preferably, the material has an average particle size of less than about 150 nm, such as about 10 nm to about 25, about 50, about 75, or about 100 nm. In embodiments, the nanosized particles can range in average particle size, d₅₀, or average particle diameter as measured by TEM imaging, from about 10 nm to about 250 nm, such as from about 25 nm to about 150 nm, or from about 50 nm to about 125 nm. Nanoscale particles are included within the scope of microencapsulated particles. In general, smaller microencapsulated particles improve dispersion stability of particles in lubricant blends.

It has now been found that extending performance of a lubricating oil in an engine or other mechanical component lubricated with the lubricating oil can be achieved by using as the lubricating oil a formulated oil that has a lubricating oil base stock as a major component, and at least one microencapsulated lubricating oil additive, as a minor component. The at least one microencapsulated lubricating oil additive comprises an encapsulating material and a core material encapsulated by the encapsulating material. The encapsulating material comprises a polymeric matrix and the core material comprises at least one lubricating oil additive. The lubricating oils of this disclosure are particularly advantageous as passenger vehicle engine oil (PVEO) products.

It has also been found that duration of performance of a lubricating oil in an engine or other mechanical component lubricated with the lubricating oil is extended as compared to duration of performance of a lubricating oil containing a minor component other than the at least one microencapsulated lubricating oil additive.

It has further been found that solubility, compatibility and/or dispersion of lubricating oil additives in a lubricating oil is improved by using as the lubricating oil a formulated oil that has a lubricating oil base stock as a major component, and at least one microencapsulated lubricating oil additive, as a minor component. The at least one microencapsulated lubricating oil additive comprises an encapsulating material and a core material encapsulated by the encapsulating material. The encapsulating material comprises a polymeric matrix and the core material comprises at least one lubricating oil additive.

In accordance with this disclosure, the use of microencapsulated lubricating oil additives enables a controlled release of the lubricating oil additives over the service life of the lubricating oil. One advantage of this disclosure is an increased efficacy for lubricating oil additives that benefit from controlling the time and/or location of their respective release to when (e.g., uphill driving or during heavy tow of a trailer) or where (e.g., adjacent a piston) they are most needed. The microencapsulated lubricating oil additives of this disclosure may also serve to reduce the total amount of lubricating oil additive required, thereby reducing costs and unwanted emissions.

The microencapsulated lubricating oil additives can be contained within a polymer matrix and undergo release by diffusion or rupture of the polymer matrix due to a high friction contact with a piston. Alternatively, the microencapsulated lubricating oil additive can be contained within a polymer matrix that slowly dissolves and releases the microencapsulated additive. In various aspects, the release rate of the microencapsulated additive need not be entirely passive, rather it can be responsive to specific conditions or localized events, such as elevated temperatures, changing pH, high mechanical stress in the contact between moving parts, oxidation and degradation in the presence of air or combustion gasses or severe operating conditions.

In an embodiment, the core material comprising at least one lubricating oil additive is controllably released into the lubricating oil by thermal degradation, chemical degradation, or mechanical degradation of the polymeric matrix.

A wide range of materials and methods for encapsulation are commercially available that provide for a variety of strategies to create the degree of durability and method of release of the lubricating oil additives from encapsulation into the lubricating oil. The microencapsulated lubricating oil additives of this disclosure include any particular type of microencapsulating material or production method, preferably a polymer matrix manufactured by solvent evaporation. Illustrative polymeric shell or matrix materials suitable for use with the microencapsulated lubricating oil additives include, for example, polyurethanes, polyureas, polyesters, polycyanoacrylates, phenol-formaldehyde, melamine-formaldehyde resins, and combinations thereof. Certain hydrophobic polymers, such as poly(methylmethacrylate), may also be used. Various physical and chemical methods of microencapsulation may be used, depending upon the oil additive and the desired polymeric shell or matrix to be used.

A preferred microencapsulation method is polymer matrix microencapsulation. Illustrative polymer types useful in polymer matrix microencapsulation include, for example, polymethyl methacrylate (PMMA), polyvinyl pyrrolidone (PVP), polyvinyl alcohol (PVOH), hydroxypropyl cellulose (HPC), ethyl cellulose (EC), ethyl cyanoacrylate, polycyanoacrylate, poly(alpha-methyl styrene), and the like. A preferred method for manufacturing the microcapsules involves solvent evaporation. The polymer matrix microencapsulation method can be completed in an aqueous phase or hydrocarbon phase.

The polymer matrix microencapsulation method can be conducted by a two-phase solvent evaporation method, where the dispersed phase contains a volatile solvent, matrix polymer, and oil additive. The continuous phase can be either aqueous or non-aqueous. The dispersed phase is preferably a liquid phase that is insoluble in the continuous phase. The major component of the dispersed phase is a volatile solvent. The volatile solvent contains dissolved matrix material and dissolved or dispersed oil additives. Homogenization, such as rotator-stator mixing, ultrasonic mixing, or high pressure homogenization, is used to reduce and control the droplet size of the dispersed phase. Surfactants, dispersants, or viscosity modifiers may be added to either phase to facilitate the formulation of a stable emulsion. Once a suitable emulsion is formed, the solvent from the dispersed phase is removed over time, and may be accelerated with the use of vacuum or heat. The end result is a suspension of matrix capsules containing oil additives.

Preferred polymer types useful in polymer matrix microencapsulation include, for example, polyvinyl pyrrolidone (PVP), hydroxypropyl cellulose (HPC), and ethyl cellulose (EC). More preferred polymer types useful in polymer matrix microencapsulation include polyvinyl pyrrolidone (PVP) or ethyl cellulose (EC).

Another microencapsulation method is core shell microencapsulation. Illustrative polymer types useful in core shell microencapsulation include, for example, polyurea, polyurethane, polyamides, polyesters, and the like. Methods for manufacturing the microcapsules include interfacial polymerization and coacervation. Surfactants such as Tween, SDS, Brij, and the like can be used during manufacture to facilitate core shell microencapsulation.

The core shell microencapsulation method can be conducted by preparing a two-phase liquid system where each phase contains a monomer for preparation of the interfacial shell. One phase can contain multifunctional isocyanates or acyl chlorides, while the other phase contains multifunctional alcohols or amines. The monomers react at the interface of the two phases to produce a microcapsule shell. The process is historically carried out with an oil-in-water emulsion, where the oil phase contains the isocyanate or acyl chloride monomer and core material, such as an oil additive, for encapsulation. A reverse phase system can also be prepared with water-in-oil emulsions, or the use of oil-in-oil emulsions with two immiscible phases. Additional methods for the preparation of core-shell microcapsules include simple coacervation, complex coacervation, and in situ polymerization.

In an embodiment, the polymeric matrix is selected so as to not to be soluble in the lubricating base oil and to not degrade unless intended. In order for the microencapsulated lubricating oil additives to freely travel into small areas and without entrapment in a typical oil filter or the like, the microencapsulated oil additives have an average particle size of less than about 5 μm, less than about 4 μm, less than about 3 μm, less than about 2 μm, or less than about 1 μm, and even smaller (e.g., 100 nm). Larger average particle sizes may be used if the conditions are warranted and the particular circulation system accommodates larger particles. It should be understood that particle size and morphology may be tailored to achieve the desired performance. They may also be tailored to accommodate various oil filters, filtration systems and their related requirements. In various aspects the thickness of the polymeric matrix may be tailored for specific uses and release triggers, and may be less than about 1 μm, less than about 0.75 μm, less than about 0.5 μm, or less than about 100 nm, and even smaller.

Preferably, the at least one microencapsulated lubricating oil additive comprises particles having an average particle size from about 100 nanometers (nm) to about 1 micrometer (μm).

In accordance with this disclosure, the overall microencapsulated particle size and/or coating thickness can be tailored to assure the microencapsulated oil additives are not retained in oil filters. Alternatively, the filter minimum capture size can be modified for use with microencapsulated lubricating oil additives of this disclosure. Other reasons for tailoring the size may include the durability of microcapsules exposed to moderate shear stress under general engine operating conditions. For example, larger capsules commonly produced by mechanical dispersion methods (typically 50-500 μm) may rupture too rapidly. However, microcapsule sizes extending down into the nanometer range can be created using known physiochemical methods. The production of smaller capsule sizes in the range of 10 μm or less by mechanical dispersion has been demonstrated by use of higher mechanical shear energy.

The subsequent durability and sensitivity of the polymeric matrix to break down or release under mechanical or thermal stress, or other environmental factors, can be controlled by selection of polymer variants and use of crosslinking agents. For example, polymer matrices can be created to respond to a changing chemical environment, which will swell and accelerate release of the oil additive material when the pH increases or decreases to a predetermined level. Other polymer matrices can be created having a thermal profile may degrade and accelerate release of the lubricating oil additive material when the temperature increases to a predetermined level.

The size of the remnants of the polymer matrix (post oil additive release) should be tailored such that they will continue to circulate within the lubricant without agglomeration or otherwise be susceptible to entrapment within a filter material. In accordance with this disclosure, the polymer matrix may be tailored such that it degrades to fragments having an average particle size of less than about 1μm, or less than about 0.1 μm, during certain conditions.

Lubricating oil additives may deplete during operation of the engine or other mechanical component. In accordance with this disclosure, the microencapsulated lubricating oil additives dispense the core additives into the lubricating oil to replenish depleted additives during certain conditions. A method of this disclosure provides for the controlled release of the lubricating oil additives based on certain conditions that can be custom tailored and designed by the specific encapsulation material used, as well as its thickness. Certain conditions include, for example, a predetermined temperature change, a predetermined pH change, a localized high friction contact, and combinations thereof.

The microencapsulated lubricating oil additives can contain one or more performance additives. For example, the microencapsulated lubricating oil additives can contain any permissible combination of a friction modifier, antiwear additive, viscosity modifier, antioxidant, detergent, dispersant, pour point depressant, corrosion inhibitor, metal deactivator, seal compatibility additive, anti-foam agent, inhibitor, and anti-rust additive. In an embodiment, the microencapsulated lubricating oil additives can contain any permissible combination of a friction modifier, antioxidant, detergent, corrosion inhibitor, and rust inhibitor.

In accordance with this disclosure, a method is provided for extending the performance of lubricating oil additives through microencapsulation. The lubricating oil additives are slowly released into the bulk fluid through various mechanisms including, but not limited to, diffusion, thermal degradation, chemical degradation and mechanical degradation of the polymer matrix capsule. Such mechanisms can be triggered by thermal, oxidative, fluid shear, entrapment between lubricated surfaces, changes to acid/base balance, and/or presence of water. The slow release of the lubricating oil additive into the bulk fluid allows the fluid to maintain levels of active lubricating oil additive concentrations that enables extended performance beyond that possible with an initial treat of non-encapsulated lubricating oil additive.

The microcapsules of this disclosure also provide improved additive dispersion and storage stability, thus providing a method to deliver performance additives to the fluid that may be insoluble in the bulk. This allows for performance additives to be considered for use that otherwise would have been overlooked or dismissed for commercial viability. It also enables the use of additive combinations that otherwise may be antagonistic when combined in their neat state.

The microencapsulated lubricating oil additives can be used in combination with one or more lubricating oil additives that are not lubricated. For example, the lubricating oil can have a combination of microencapsulated lubricating oil additives (e.g., a microencapsulated friction modifier, antioxidant, detergent, corrosion inhibitor, and/or rust inhibitor) and non-microencapsulated lubricating oil additives (e.g., a non-microencapsulated friction modifier, antioxidant, detergent, corrosion inhibitor, and/or rust inhibitor).

In an embodiment, this disclosure provides a method by which lubricating oil performance additives are encapsulated in polymer microcapsules of either core shell or polymer matrix type. In the microcapsule form, the individual additives are considered inactive as they are prevented from delivering performance to the bulk fluid. In addition, the microencapsulated additives are protected from degradation due to the service environment (e.g., thermal, oxidative, acids, and the like). The microencapsulated additives are slowly released into the bulk fluid through diffusion, thermal, mechanical or oxidative degradation of the polymer capsule, which can be triggered by thermal, oxidative, fluid shear, mechanical stress, changes in pH and/or water. The slow release of the additive into the bulk fluid allows the fluid to maintain a constant level of active additive resulting in an extended performance.

The lubricant compositions of this disclosure provide extended performance (e.g., friction and wear) in the lubrication of internal combustion engines, power trains, drivelines, transmissions, gears, gear trains, gear sets, compressors, pumps, hydraulic systems, bearings, bushings, turbines, and the like.

Also, the lubricant compositions of this disclosure provide extended performance (e.g., friction and wear) in the lubrication of mechanical components, which can include, for example, pistons, piston rings, cylinder liners, cylinders, cams, tappets, lifters, bearings (journal, roller, tapered, needle, ball, and the like), gears, valves, and the like.

The lubricant compositions of this disclosure are useful in additive concentrates that include the combination of the minor component of this disclosure with at least one other additive component, having combined weight % concentrations in the range of 0.1% to 80%, preferably 0.1% to 60%, more preferably 0.1% to 50%, even more preferably 0.1% to 40%, and in some instances preferably 0.1% to 30%. Under some circumstances, the combined weight % concentrations cited above may be in the range of 0.1% to 20%, and preferably 0.1% to 10%, more preferably 0.1% to 8%, even more preferably 0.1% to 5%.

Yet further, the lubricant compositions of this disclosure provide extended performance (e.g., friction and wear) under diverse lubrication regimes, that include, for example, hydrodynamic, elastohydrodynamic, boundary, mixed lubrication, extreme pressure regimes, and the like.

The lubricant compositions of this disclosure provide extended performance (e.g., friction and wear) under a range of lubrication contact pressures, less than 1 MPa, and from 1 MPas to greater than 10 GPa, preferably greater than 10 MPa, more preferably greater than 100 MPa, even more preferably greater than 300 MPa. Under certain circumstances, the lubricant compositions of this disclosure provide extended performance (e.g., friction and wear) at greater than 0.5 GPa, often at greater than 1 GPa, sometimes greater than 2 GPa, under selected circumstances greater than 5 GPa.

Also, the lubricant compositions of this disclosure provide extended performance (e.g., friction and wear) in spark-ignition internal combustion engines, compression-ignition internal combustion engines, mixed-ignition (spark-assisted and compression) internal combustion engines, jet- or plasma-ignition internal combustion engines, and the like.

Further, the lubricant compositions of this disclosure provide extended performance (e.g., friction and wear) in diverse engine and power plant types, which can include, for example, the following: 2-stroke engines; 4-stroke engine; engines with alternate stroke designs greater than 2-stroke, such as 5-stroke, or 7-stroke, and the like; rotary engines; dedicated EGR (exhaust gas recirculation) fueled engines; free-piston type engines; opposable-piston opposable-cylinder type engines; engines that function in hybrid propulsion systems, that can further include electrical-based power systems, hydraulic-based power systems, diverse system designs such as parallel, series, non-parallel, and the like.

Yet further, the lubricant compositions of this disclosure provide extended performance (e.g., friction and wear) in, for example, the following: naturally aspirated engines; turbocharged and supercharged, port-fueled injection engines; turbocharged and supercharged, direct injection engines (for gasoline, diesel, natural gas, mixtures of these, and other fuel types); turbocharged engines designed to operate with in-cylinder combustion pressures of greater than 12 bar, preferably greater than 18 bar, more preferably greater than 20 bar, even more preferably greater than 22 bar, and in certain instances combustion pressures greater than 24 bar, even greater than 26 bar, and even more so greater than 28 bar, and with particular designs greater than 30 bar; engines having low-temperature burn combustion, lean-burn combustion, and high thermal efficiency designs.

Also, the lubricant compositions of this disclosure provide extended performance (e.g., friction and wear) in engines that are fueled with fuel compositions that include, for example, the following: gasoline; distillate fuel, diesel fuel, jet fuel, gas-to-liquid and Fischer-Tropsch-derived high-cetane fuels; compressed natural gas, liquefied natural gas, methane, ethane, propane, other natural gas components, other natural gas liquids; ethanol, methanol, other higher MW alcohols; FAMES, vegetable-derived esters and polyesters; biodiesel, bio-derived and bio-based fuels; hydrogen; dimethyl ether; other alternate fuels; fuels diluted with EGR (exhaust gas recirculation) gases, with EGR gases enriched in hydrogen or carbon monoxide or combinations of H₂/CO, in both dilute and high concentration (in concentrations of >0.1%, preferably >0.5%, more preferably >1%, even more preferably >2%, and even more so preferably >3%), and blends or combinations of these in proportions that enhance combustion efficiency, power, cleanliness, anti-knock, and anti-LSPI (low speed pre-ignition).

Further, the lubricant compositions of this disclosure provide extended performance (e.g., friction and wear) on lubricated surfaces that include, for example, the following: metals, metal alloys, non-metals, non-metal alloys, mixed carbon-metal composites and alloys, mixed carbon-nonmetal composites and alloys, ferrous metals, ferrous composites and alloys, non-ferrous metals, non-ferrous composites and alloys, titanium, titanium composites and alloys, aluminum, aluminum composites and alloys, magnesium, magnesium composites and alloys, ion-implanted metals and alloys, plasma modified surfaces; surface modified materials; coatings; mono-layer, multi-layer, and gradient layered coatings; honed surfaces; polished surfaces; etched surfaces; textured surfaces; mircro and nano structures on textured surfaces; super-finished surfaces; diamond-like carbon (DLC), DLC with high-hydrogen content, DLC with moderate hydrogen content, DLC with low-hydrogen content, DLC with near-zero hydrogen content, DLC composites, DLC-metal compositions and composites, DLC-nonmetal compositions and composites; ceramics, ceramic oxides, ceramic nitrides, FeN, CrN, ceramic carbides, mixed ceramic compositions, and the like; polymers, thermoplastic polymers, engineered polymers, polymer blends, polymer alloys, polymer composites; materials compositions and composites containing dry lubricants, that include, for example, graphite, carbon, molybdenum, molybdenum disulfide, polytetrafluoroethylene, polyperfluoropropylene, polyperfluoroalkylethers, and the like.

Yet further, the lubricant compositions of this disclosure provide extended performance (e.g., friction and wear) on lubricated surfaces of 3-D printed materials, and similar materials derived from additive manufacturing techniques, with or without post-printing surface finishing; surfaces of 3-D printed materials that have been post-printing treated with coatings, which may include plasma spray coatings, ion beam-generated coatings, electrolytically- or galvanically-generated coatings, electro-deposition coatings, vapor-deposition coatings, liquid-deposition coatings, thermal coatings, laser-based coatings; surfaces of 3-D printed materials, where the surfaces may be as-printed, finished, or coated, that include: metals, metal alloys, non-metals, non-metal alloys, mixed carbon-metal composites and alloys, mixed carbon-nonmetal composites and alloys, ferrous metals, ferrous composites and alloys, non-ferrous metals, non-ferrous composites and alloys, titanium, titanium composites and alloys, aluminum, aluminum composites and alloys, magnesium, magnesium composites and alloys, ion-implanted metals and alloys; plasma modified surfaces; surface modified materials; mono-layer, multi-layer, and gradient layered coatings; honed surfaces; polished surfaces; etched surfaces; textured surfaces; micro and nano structures on textured surfaces; super-finished surfaces; diamond-like carbon (DLC), DLC with high-hydrogen content, DLC with moderate hydrogen content, DLC with low-hydrogen content, DLC with near-zero hydrogen content, DLC composites, DLC-metal compositions and composites, DLC-nonmetal compositions and composites; ceramics, ceramic oxides, ceramic nitrides, FeN, CrN, ceramic carbides, mixed ceramic compositions, and the like; polymers, thermoplastic polymers, engineered polymers, polymer blends, polymer alloys, polymer composites; materials compositions and composites containing dry lubricants, that include, for example, graphite, carbon, molybdenum, molybdenum di sulfide, polytetrafluoroethylene, polyperfluoropropylene, polyperfluoroalkylethers, and the like.

Still further, the lubricant compositions of this disclosure provide extended synergistic performance (e.g., synergistic friction and wear) in combination with one or more performance additives, with performance additives at effective concentration ranges, and with performance additives at effective ratios with the minor component of this disclosure.

### Lubricating Oil Base Stocks

In accordance with this disclosure, the lubricating oil compositions contain a lubricating oil base stock. In addition, the lubricating oil compositions of this disclosure can optionally contain a lubricating oil co-base stock.

A wide range of lubricating base oils is known in the art. Lubricating base oils that are useful in the present disclosure are natural oils, mineral oils and synthetic oils, and unconventional oils (or mixtures thereof) can be used unrefined, refined, or rerefined (the latter is also known as reclaimed or reprocessed oil). Unrefined oils are those obtained directly from a natural or synthetic source and used without added purification. These include shale oil obtained directly from retorting operations, petroleum oil obtained directly from primary distillation, and ester oil obtained directly from an esterification process. Refined oils are similar to the oils discussed for unrefined oils except refined oils are subjected to one or more purification steps to improve at least one lubricating oil property. One skilled in the art is familiar with many purification processes. These processes include solvent extraction, secondary distillation, acid extraction, base extraction, filtration, and percolation. Rerefined oils are obtained by processes analogous to refined oils but using an oil that has been previously used as a feed stock.

Groups I, II, III, IV and V are broad base oil stock categories developed and defined by the American Petroleum Institute (API Publication 1509; www.API.org) to create guidelines for lubricant base oils. Group I base stocks have a viscosity index of between about 80 to 120 and contain greater than about 0.03% sulfur and/or less than about 90% saturates. Group II base stocks have a viscosity index of between about 80 to 120, and contain less than or equal to about 0.03% sulfur and greater than or equal to about 90% saturates. Group III stocks have a viscosity index greater than about 120 and contain less than or equal to about 0.03% sulfur and greater than about 90% saturates. Group IV includes polyalphaolefins (PAO). Group V base stock includes base stocks not included in Groups I-IV. The table below summarizes properties of each of these five groups.

| | Base Oil Properties | | |
|---|---|---|---|
| | Saturates | Sulfur | Viscosity Index |
| Group I | <90 and/or | >0.03% and | ≥80 and <120 |
| Group II | ≥90 and | ≤0.03% and | ≥80 and <120 |
| Group III | ≥90 and | ≤0.03% and | ≥120 |

| | |
|---|---|
| Group IV | polyalphaolefins (PAO) |
| Group V | All other base oil stocks not included in Groups I, II, III or IV |

Natural oils include animal oils, vegetable oils (castor oil and lard oil, for example), and mineral oils. Animal and vegetable oils possessing favorable thermal oxidative stability can be used. Of the natural oils, mineral oils are preferred. Mineral oils vary widely as to their crude source, for example, as to whether they are paraffinic, naphthenic, or mixed paraffinic-naphthenic. Oils derived from coal or shale are also useful. Natural oils vary also as to the method used for their production and purification, for example, their distillation range and whether they are straight run or cracked, hydrorefined, or solvent extracted.

Group II and/or Group III hydroprocessed or hydrocracked base stocks are also well known base stock oils.

Synthetic oils include hydrocarbon oil. Hydrocarbon oils include oils such as polymerized and interpolymerized olefins (polybutylenes, polypropylenes, propylene isobutylene copolymers, ethylene-olefin copolymers, and ethylene-alphaolefin copolymers, for example). Polyalphaolefin (PAO) oil base stocks are commonly used synthetic hydrocarbon oil. By way of example, PAOs derived from C₈, C₁₀, C₁₂, C₁₄ olefins or mixtures thereof may be utilized. See U.S. Pat. Nos. 4,956,122; 4,827,064; and 4,827,073.

The number average molecular weights of the PAOs, which are known materials and generally available on a major commercial scale from suppliers such as ExxonMobil Chemical Company, Chevron Phillips Chemical Company, BP, and others, typically vary from about 250 to about 3,000, although PAO's may be made in viscosities up to about 150 cSt (100° C.). The PAOs are typically comprised of relatively low molecular weight hydrogenated polymers or oligomers of alphaolefins which include, but are not limited to, C₂ to about C₃₂ alphaolefins with the C₈ to about C₁₆ alphaolefins, such as 1-octene, 1-decene, 1-dodecene and the like, being preferred. The preferred polyalphaolefins are poly-1-octene, poly-1-decene and poly-1-dodecene and mixtures thereof and mixed olefin-derived polyolefins. However, the dimers of higher olefins in the range of C₁₂ to C₁₈ may be used to provide low viscosity base stocks of acceptably low volatility. Depending on the viscosity grade and the starting oligomer, the PAOs may be predominantly dimers, trimers and tetramers of the starting olefins, with minor amounts of the lower and/or higher oligomers, having a viscosity range of 1.5 cSt to 12 cSt. PAO fluids of particular use may include 3 cSt, 3.4 cSt, and/or 3.6 cSt and combinations thereof. Mixtures of PAO fluids having a viscosity range of 1.5 cSt to approximately 150 cSt or more may be used if desired. Unless indicated otherwise, all viscosities cited herein are measured at 100° C.

The PAO fluids may be conveniently made by the polymerization of an alphaolefin in the presence of a polymerization catalyst such as the Friedel-Crafts catalysts including, for example, aluminum trichloride, boron trifluoride or complexes of boron trifluoride with water, alcohols such as ethanol, propanol or butanol, carboxylic acids or esters such as ethyl acetate or ethyl propionate. For example the methods disclosed by U.S. Pat. Nos. 4,149,178 or 3,382,291 may be conveniently used herein. Other descriptions of PAO synthesis are found in the following U.S. Pat. Nos. 3,742,082; 3,769,363; 3,876,720; 4,239,930; 4,367,352; 4,413,156; 4,434,408; 4,910,355; 4,956,122; and 5,068,487. The dimers of the C₁₄ to C₁₈ olefins are described in U.S. Pat. No. 4,218,330.

Other useful lubricant oil base stocks include wax isomerate base stocks and base oils, comprising hydroisomerized waxy stocks (e.g. waxy stocks such as gas oils, slack waxes, fuels hydrocracker bottoms, etc.), hydroisomerized Fischer-Tropsch waxes, Gas-to-Liquids (GTL) base stocks and base oils, and other wax isomerate hydroisomerized base stocks and base oils, or mixtures thereof. Fischer-Tropsch waxes, the high boiling point residues of Fischer-Tropsch synthesis, are highly paraffinic hydrocarbons with very low sulfur content. The hydroprocessing used for the production of such base stocks may use an amorphous hydrocracking/hydroisomerization catalyst, such as one of the specialized lube hydrocracking (LHDC) catalysts or a crystalline hydrocracking/hydroisomerization catalyst, preferably a zeolitic catalyst. For example, one useful catalyst is ZSM-48 as described in U.S. Pat. No. 5,075,269, the disclosure of which is incorporated herein by reference in its entirety. Processes for making hydrocracked/hydroisomerized distillates and hydrocracked/hydroisomerized waxes are described, for example, in U.S. Pat. Nos. 2,817,693; 4,975,177; 4,921,594 and 4,897,178 as well as in British Patent Nos. 1,429,494; 1,350,257; 1,440,230 and 1,390,359. Each of the aforementioned patents is incorporated herein in their entirety. Particularly favorable processes are described in European Patent Application Nos. 464546 and 464547, also incorporated herein by reference. Processes using Fischer-Tropsch wax feeds are described in U.S. Pat. Nos. 4,594,172 and 4,943,672, the disclosures of which are incorporated herein by reference in their entirety.

Gas-to-Liquids (GTL) base oils, Fischer-Tropsch wax derived base oils, and other wax-derived hydroisomerized (wax isomerate) base oils be advantageously used in the instant disclosure, and may have useful kinematic viscosities at 100° C. of about 2 cSt to about 50 cSt, preferably about 2 cSt to about 30 cSt, more preferably about 3 cSt to about 25 cSt, as exemplified by GTL 4 with kinematic viscosity of about 4.0 cSt at 100° C. and a viscosity index of about 141. These Gas-to-Liquids (GTL) base oils, Fischer-Tropsch wax derived base oils, and other wax-derived hydroisomerized base oils may have useful pour points of about −20° C. or lower, and under some conditions may have advantageous pour points of about −25° C. or lower, with useful pour points of about −30° C. to about −40° C. or lower. Useful compositions of Gas-to-Liquids (GTL) base oils, Fischer-Tropsch wax derived base oils, and wax-derived hydroisomerized base oils are recited in U.S. Pat. Nos. 6,080,301; 6,090,989, and 6,165,949 for example, and are incorporated herein in their entirety by reference.

The hydrocarbyl aromatics can be used as a base oil or base oil component and can be any hydrocarbyl molecule that contains at least about 5% of its weight derived from an aromatic moiety such as a benzenoid moiety or naphthenoid moiety, or their derivatives. These hydrocarbyl aromatics include alkyl benzenes, alkyl naphthalenes, alkyl biphenyls, alkyl diphenyl oxides, alkyl naphthols, alkyl diphenyl sulfides, alkylated bis-phenol A, alkylated thiodiphenol, and the like. The aromatic can be mono-alkylated, dialkylated, polyalkylated, and the like. The aromatic can be mono- or poly-functionalized. The hydrocarbyl groups can also be comprised of mixtures of alkyl groups, alkenyl groups, alkynyl, cycloalkyl groups, cycloalkenyl groups and other related hydrocarbyl groups. The hydrocarbyl groups can range from about C₆ up to about C₆₀ with a range of about C₈ to about C₂₀ often being preferred. A mixture of hydrocarbyl groups is often preferred, and up to about three such substituents may be present. The hydrocarbyl group can optionally contain sulfur, oxygen, and/or nitrogen containing substituents. The aromatic group can also be derived from natural (petroleum) sources, provided at least about 5% of the molecule is comprised of an above-type aromatic moiety. Viscosities at 100° C. of approximately 2 cSt to about 50 cSt are preferred, with viscosities of approximately 3 cSt to about 20 cSt often being more preferred for the hydrocarbyl aromatic component. In one embodiment, an alkyl naphthalene where the alkyl group is primarily comprised of 1-hexadecene is used. Other alkylates of aromatics can be advantageously used. Naphthalene or methyl naphthalene, for example, can be alkylated with olefins such as octene, decene, dodecene, tetradecene or higher, mixtures of similar olefins, and the like. Alkylated naphthalene and analogues may also comprise compositions with isomeric distribution of alkylating groups on the alpha and beta carbon positions of the ring structure. Distribution of groups on the alpha and beta positions of a naphthalene ring may range from 100:1 to 1:100, more often 50:1 to 1:50 Useful concentrations of hydrocarbyl aromatic in a lubricant oil composition can be about 2% to about 25%, preferably about 4% to about 20%, and more preferably about 4% to about 15%, depending on the application.

Alkylated aromatics such as the hydrocarbyl aromatics of the present disclosure may be produced by well-known Friedel-Crafts alkylation of aromatic compounds. See Friedel-Crafts and Related Reactions, Olah, G. A. (ed.), Inter-science Publishers, N.Y., 1963. For example, an aromatic compound, such as benzene or naphthalene, is alkylated by an olefin, alkyl halide or alcohol in the presence of a Friedel-Crafts catalyst. See Friedel-Crafts and Related Reactions, Vol. 2, part 1, chapters 14, 17, and 18, See Olah, G. A. (ed.), Inter-science Publishers, N.Y., 1964. Many homogeneous or heterogeneous, solid catalysts are known to one skilled in the art. The choice of catalyst depends on the reactivity of the starting materials and product quality requirements. For example, strong acids such as AlCl₃, BF₃, or HF may be used. In some cases, milder catalysts such as FeCl₃ or SnCl₄ are preferred. Newer alkylation technology uses zeolites or solid super acids.

Esters comprise a useful base stock. Additive solvency and seal compatibility characteristics may be secured by the use of esters such as the esters of dibasic acids with monoalkanols and the polyol esters of monocarboxylic acids. Esters of the former type include, for example, the esters of dicarboxylic acids such as phthalic acid, succinic acid, alkyl succinic acid, alkenyl succinic acid, maleic acid, azelaic acid, suberic acid, sebacic acid, fumaric acid, adipic acid, linoleic acid dimer, malonic acid, alkyl malonic acid, alkenyl malonic acid, etc., with a variety of alcohols such as butyl alcohol, hexyl alcohol, dodecyl alcohol, 2-ethylhexyl alcohol, etc. Specific examples of these types of esters include dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, etc.

Particularly useful synthetic esters are those which are obtained by reacting one or more polyhydric alcohols, preferably the hindered polyols (such as the neopentyl polyols, e.g., neopentyl glycol, trimethylol ethane, 2-methyl-2-propyl-1,3-propanediol, trimethylol propane, pentaerythritol and dipentaerythritol) with alkanoic acids containing at least about 4 carbon atoms, preferably C₅ to C₃₀ acids such as saturated straight chain fatty acids including caprylic acid, capric acid, lauric acid, myristic acid, palmitic acid, stearic acid, arachic acid, and behenic acid, or the corresponding branched chain fatty acids or unsaturated fatty acids such as oleic acid, or mixtures of any of these materials.

Suitable synthetic ester components include the esters of trimethylol propane, trimethylol butane, trimethylol ethane, pentaerythritol and/or dipentaerythritol with one or more monocarboxylic acids containing from about 5 to about 10 carbon atoms. These esters are widely available commercially, for example, the Mobil P-41 and P-51 esters of ExxonMobil Chemical Company.

Also useful are esters derived from renewable material such as coconut, palm, rapeseed, soy, sunflower and the like. These esters may be monoesters, di-esters, polyol esters, complex esters, or mixtures thereof. These esters are widely available commercially, for example, the Mobil P-51 ester of ExxonMobil Chemical Company.

Engine oil formulations containing renewable esters are included in this disclosure. For such formulations, the renewable content of the ester is typically greater than about 70 weight percent, preferably more than about 80 weight percent and most preferably more than about 90 weight percent.

Other useful fluids of lubricating viscosity include non-conventional or unconventional base stocks that have been processed, preferably catalytically, or synthesized to provide high performance lubrication characteristics.

Non-conventional or unconventional base stocks/base oils include one or more of a mixture of base stock(s) derived from one or more Gas-to-Liquids (GTL) materials, as well as isomerate/isodewaxate base stock(s) derived from natural wax or waxy feeds, mineral and or non-mineral oil waxy feed stocks such as slack waxes, natural waxes, and waxy stocks such as gas oils, waxy fuels hydrocracker bottoms, waxy raffinate, hydrocrackate, thermal crackates, or other mineral, mineral oil, or even non-petroleum oil derived waxy materials such as waxy materials received from coal liquefaction or shale oil, and mixtures of such base stocks.

GTL materials are materials that are derived via one or more synthesis, combination, transformation, rearrangement, and/or degradation/deconstructive processes from gaseous carbon-containing compounds, hydrogen-containing compounds and/or elements as feed stocks such as hydrogen, carbon dioxide, carbon monoxide, water, methane, ethane, ethylene, acetylene, propane, propylene, propyne, butane, butylenes, and butynes. GTL base stocks and/or base oils are GTL materials of lubricating viscosity that are generally derived from hydrocarbons; for example, waxy synthesized hydrocarbons, that are themselves derived from simpler gaseous carbon-containing compounds, hydrogen-containing compounds and/or elements as feed stocks. GTL base stock(s) and/or base oil(s) include oils boiling in the lube oil boiling range (1) separated/fractionated from synthesized GTL materials such as, for example, by distillation and subsequently subjected to a final wax processing step which involves either or both of a catalytic dewaxing process, or a solvent dewaxing process, to produce lube oils of reduced/low pour point; (2) synthesized wax isomerates, comprising, for example, hydrodewaxed or hydroisomerized cat and/or solvent dewaxed synthesized wax or waxy hydrocarbons; (3) hydrodewaxed or hydroisomerized cat and/or solvent dewaxed Fischer-Tropsch (F-T) material (i.e., hydrocarbons, waxy hydrocarbons, waxes and possible analogous oxygenates); preferably hydrodewaxed or hydroisomerized/followed by cat and/or solvent dewaxing dewaxed F-T waxy hydrocarbons, or hydrodewaxed or hydroisomerized/followed by cat (or solvent) dewaxing dewaxed, F-T waxes, or mixtures thereof

GTL base stock(s) and/or base oil(s) derived from GTL materials, especially, hydrodewaxed or hydroisomerized/followed by cat and/or solvent dewaxed wax or waxy feed, preferably F-T material derived base stock(s) and/or base oil(s), are characterized typically as having kinematic viscosities at 100° C. of from about 2 mm²/s to about 50 mm²/s (ASTM D445). They are further characterized typically as having pour points of −5° C. to about −40° C. or lower (ASTM D97). They are also characterized typically as having viscosity indices of about 80 to about 140 or greater (ASTM D2270).

In addition, the GTL base stock(s) and/or base oil(s) are typically highly paraffinic (>90% saturates), and may contain mixtures of monocycloparaffins and multicycloparaffins in combination with non-cyclic isoparaffins. The ratio of the naphthenic (i.e., cycloparaffin) content in such combinations varies with the catalyst and temperature used. Further, GTL base stock(s) and/or base oil(s) typically have very low sulfur and nitrogen content, generally containing less than about 10 ppm, and more typically less than about 5 ppm of each of these elements. The sulfur and nitrogen content of GTL base stock(s) and/or base oil(s) obtained from F-T material, especially F-T wax, is essentially nil. In addition, the absence of phosphorus and aromatics make this materially especially suitable for the formulation of low SAP products.

The term GTL base stock and/or base oil and/or wax isomerate base stock and/or base oil is to be understood as embracing individual fractions of such materials of wide viscosity range as recovered in the production process, mixtures of two or more of such fractions, as well as mixtures of one or two or more low viscosity fractions with one, two or more higher viscosity fractions to produce a blend wherein the blend exhibits a target kinematic viscosity.

The GTL material, from which the GTL base stock(s) and/or base oil(s) is/are derived is preferably an F-T material (i.e., hydrocarbons, waxy hydrocarbons, wax).

Base oils for use in the formulated lubricating oils useful in the present disclosure are any of the variety of oils corresponding to API Group I, Group II, Group III, Group IV, and Group V oils and mixtures thereof, preferably API Group II, Group III, Group IV, and Group V oils and mixtures thereof, more preferably the Group III to Group V base oils due to their exceptional volatility, stability, viscometric and cleanliness features. Minor quantities of Group I stock, such as the amount used to dilute additives for blending into formulated lube oil products, can be tolerated but should be kept to a minimum, i.e. amounts only associated with their use as diluent/carrier oil for additives used on an “as-received” basis. Even in regard to the Group II stocks, it is preferred that the Group II stock be in the higher quality range associated with that stock, i.e. a Group II stock having a viscosity index in the range 100<VI<120.

The base oil constitutes the major component of the engine oil lubricant composition of the present disclosure and typically is present in an amount ranging from about 6 to about 99 weight percent or from about 6 to about 95 weight percent, preferably from about 50 to about 99 weight percent or from about 70 to about 95 weight percent, and more preferably from about 85 to about 95 weight percent, based on the total weight of the composition. The base oil may be selected from any of the synthetic or natural oils typically used as crankcase lubricating oils for spark-ignited and compression-ignited engines. The base oil conveniently has a kinematic viscosity, according to ASTM standards, of about 2.5 cSt to about 18 cSt (or mm²/s) at 100° C. and preferably of about 2.5 cSt to about 12.5 cSt (or mm² /s) at 100° C., often more preferably from about 2.5 cSt to about 10 cSt. Mixtures of synthetic and natural base oils may be used if desired. Bi-modal, tri-modal, and additional combinations of mixtures of Group I, II, III, IV, and/or V base stocks may be used if desired.

A co-base stock component can be present in an amount from about 1 to about 99 weight percent, preferably from about 5 to about 95 weight percent, and more preferably from about 10 to about 90 weight percent.

### Lubricating Oil Additives

In accordance with this disclosure, the lubricating oil compositions contain at least one microencapsulated lubricating oil additive. In addition, the lubricating oil compositions of this disclosure can optionally contain at least one microencapsulated lubricating oil additive in combination with one or more lubricating oil additives that are not microencapsulated.

The lubricating oil performance additives useful in this disclosure include, but not limited to, friction modifiers, antioxidants, antiwear additives, dispersants, detergents, viscosity modifiers, corrosion inhibitors, rust inhibitors, metal deactivators, extreme pressure additives, anti-seizure agents, wax modifiers, viscosity modifiers, fluid-loss additives, seal compatibility agents, lubricity agents, anti-staining agents, chromophoric agents, defoamants, demulsifiers, densifiers, wetting agents, gelling agents, tackiness agents, colorants, and others. For a review of many commonly used additives, see Klamann in Lubricants and Related Products, Verlag Chemie, Deerfield Beach, Fla.; ISBN 0-89573-177-0. Reference is also made to “Lubricant Additives” by M. W. Ranney, published by Noyes Data Corporation of Parkridge, N.J. (1973); see also U.S. Pat. No. 7,704,930, the disclosure of which is incorporated herein in its entirety. These additives are commonly delivered with varying amounts of diluent oil, that may range from 5 weight percent to 50 weight percent.

The additives useful in this disclosure do not have to be soluble in the lubricating oils. Insoluble additives in oil can be dispersed in the lubricating oils of this disclosure.

The types and quantities of performance additives used in combination with the instant disclosure in lubricant compositions are not limited by the examples shown herein as illustrations.

### Friction Modifiers

A friction modifier is any material or materials that can alter the coefficient of friction of a surface lubricated by any lubricant or fluid containing such material(s). Friction modifiers, also known as friction reducers, or lubricity agents or oiliness agents, and other such agents that change the ability of base oils, formulated lubricant compositions, or functional fluids, to modify the coefficient of friction of a lubricated surface may be effectively used in combination with the base oils or lubricant compositions of the present disclosure if desired. Friction modifiers that lower the coefficient of friction are particularly advantageous in combination with the base oils and lube compositions of this disclosure.

Illustrative friction modifiers may include, for example, organometallic compounds or materials, or mixtures thereof. Illustrative organometallic friction modifiers useful in the lubricating engine oil formulations of this disclosure include, for example, molybdenum amine, molybdenum diamine, an organotungstenate, a molybdenum dithiocarbamate, molybdenum dithiophosphates, molybdenum amine complexes, molybdenum carboxylates, and the like, and mixtures thereof. Similar tungsten based compounds may be preferable.

Other illustrative friction modifiers useful in the lubricating engine oil formulations of this disclosure include, for example, alkoxylated fatty acid esters, alkanolamides, polyol fatty acid esters, borated glycerol fatty acid esters, fatty alcohol ethers, and mixtures thereof.

Illustrative alkoxylated fatty acid esters include, for example, polyoxyethylene stearate, fatty acid polyglycol ester, and the like. These can include polyoxypropylene stearate, polyoxybutylene stearate, polyoxyethylene isosterate, polyoxypropylene isostearate, polyoxyethylene palmitate, and the like.

Illustrative alkanolamides include, for example, lauric acid diethylalkanolamide, palmic acid diethylalkanolamide, and the like. These can include oleic acid diethyalkanolamide, stearic acid diethylalkanolamide, oleic acid diethylalkanolamide, polyethoxylated hydrocarbylamides, polypropoxylated hydrocarbylamides, and the like.

Illustrative polyol fatty acid esters include, for example, glycerol mono-oleate, saturated mono-, di-, and tri-glyceride esters, glycerol mono-stearate, and the like. These can include polyol esters, hydroxyl-containing polyol esters, and the like.

Illustrative borated glycerol fatty acid esters include, for example, borated glycerol mono-oleate, borated saturated mono-, di-, and tri-glyceride esters, borated glycerol mono-sterate, and the like. In addition to glycerol polyols, these can include trimethylolpropane, pentaerythritol, sorbitan, and the like. These esters can be polyol monocarboxylate esters, polyol dicarboxylate esters, and on occasion polyoltricarboxylate esters. Preferred can be the glycerol mono-oleates, glycerol dioleates, glycerol trioleates, glycerol monostearates, glycerol distearates, and glycerol tristearates and the corresponding glycerol monopalmitates, glycerol dipalmitates, and glycerol tripalmitates, and the respective isostearates, linoleates, and the like. On occasion the glycerol esters can be preferred as well as mixtures containing any of these. Ethoxylated, propoxylated, butoxylated fatty acid esters of polyols, especially using glycerol as underlying polyol can be preferred.

Illustrative fatty alcohol ethers include, for example, stearyl ether, myristyl ether, and the like. Alcohols, including those that have carbon numbers from C₃ to C₅₀, can be ethoxylated, propoxylated, or butoxylated to form the corresponding fatty alkyl ethers. The underlying alcohol portion can preferably be stearyl, myristyl, C₁₁-C₁₃ hydrocarbon, oleyl, isosteryl, and the like.

Useful concentrations of friction modifiers may range from 0.01 weight percent to 5 weight percent, or about 0.1 weight percent to about 2.5 weight percent, or about 0.1 weight percent to about 1.5 weight percent, or about 0.1 weight percent to about 1 weight percent. Concentrations of molybdenum-containing materials are often described in terms of Mo metal concentration. Advantageous concentrations of Mo may range from 25 ppm to 700 ppm or more, and often with a preferred range of 50-200 ppm. Friction modifiers of all types may be used alone or in mixtures with the materials of this disclosure. Often mixtures of two or more friction modifiers, or mixtures of friction modifier(s) with alternate surface active material(s), are also desirable.

### Antioxidants

Antioxidants retard the oxidative degradation of base oils during service. Such degradation may result in deposits on metal surfaces, the presence of sludge, or a viscosity increase in the lubricant. One skilled in the art knows a wide variety of oxidation inhibitors that are useful in lubricating oil compositions. See, Klamann in Lubricants and Related Products, op cite, and U.S. Pat. Nos. 4,798,684 and 5,084,197, for example.

Useful antioxidants include hindered phenols. These phenolic antioxidants may be ashless (metal-free) phenolic compounds or neutral or basic metal salts of certain phenolic compounds. Typical phenolic antioxidant compounds are the hindered phenolics which are the ones which contain a sterically hindered hydroxyl group, and these include those derivatives of dihydroxy aryl compounds in which the hydroxyl groups are in the o- or p-position to each other. Typical phenolic antioxidants include the hindered phenols substituted with C₆₊ alkyl groups and the alkylene coupled derivatives of these hindered phenols. Examples of phenolic materials of this type 2-t-butyl-4-heptyl phenol; 2-t-butyl-4-octyl phenol; 2-t-butyl-4-dodecyl phenol; 2,6-di-t-butyl-4-heptyl phenol; 2,6-di-t-butyl-4-dodecyl phenol; 2-methyl-6-t-butyl-4-heptyl phenol; and 2-methyl-6-t-butyl-4-dodecyl phenol. Other useful hindered mono-phenolic antioxidants may include for example hindered 2,6-di-alkyl-phenolic proprionic ester derivatives. Bis-phenolic antioxidants may also be advantageously used in combination with the instant disclosure. Examples of ortho-coupled phenols include: 2,2′-bis(4-heptyl-6-t-butyl-phenol); 2,2′-bis(4-octyl-6-t-butyl-phenol); and 2,2′-bis(4-dodecyl-6-t-butyl-phenol). Para-coupled bisphenols include for example 4,4′-bis(2,6-di-t-butyl phenol) and 4,4′-methylene-bis(2,6-di-t-butyl phenol).

Effective amounts of one or more catalytic antioxidants may also be used. The catalytic antioxidants comprise an effective amount of a) one or more oil soluble polymetal organic compounds; and, effective amounts of b) one or more substituted N,N′-diaryl-o-phenylenediamine compounds or c) one or more hindered phenol compounds; or a combination of both b) and c). Catalytic antioxidants are more fully described in U.S. Pat. No. 8, 048,833, herein incorporated by reference in its entirety.

Non-phenolic oxidation inhibitors which may be used include aromatic amine antioxidants and these may be used either as such or in combination with phenolics. Typical examples of non-phenolic antioxidants include: alkylated and non-alkylated aromatic amines such as aromatic monoamines of the formula R⁸R⁹R¹⁰ N where R⁸ is an aliphatic, aromatic or substituted aromatic group, R⁹ is an aromatic or a substituted aromatic group, and R¹⁰ is H, alkyl, aryl or R¹¹S(O)xR¹² where R¹¹ is an alkylene, alkenylene, or aralkylene group, R¹² is a higher alkyl group, or an alkenyl, aryl, or alkaryl group, and x is 0, 1 or 2. The aliphatic group R⁸ may contain from 1 to about 20 carbon atoms, and preferably contains from about 6 to 12 carbon atoms. The aliphatic group is a saturated aliphatic group. Preferably, both R⁸ and R⁹ are aromatic or substituted aromatic groups, and the aromatic group may be a fused ring aromatic group such as naphthyl. Aromatic groups R⁸ and R⁹ may be joined together with other groups such as S.

Typical aromatic amines antioxidants have alkyl substituent groups of at least about 6 carbon atoms. Examples of aliphatic groups include hexyl, heptyl, octyl, nonyl, and decyl. Generally, the aliphatic groups will not contain more than about 14 carbon atoms. The general types of amine antioxidants useful in the present compositions include diphenylamines, phenyl naphthylamines, phenothiazines, imidodibenzyls and diphenyl phenylene diamines. Mixtures of two or more aromatic amines are also useful. Polymeric amine antioxidants can also be used. Particular examples of aromatic amine antioxidants useful in the present disclosure include: p,p′-dioctyldiphenylamine; t-octylphenyl-alpha-naphthylamine; phenyl-alphanaphthylamine; and p-octylphenyl-alpha-naphthylamine.

Sulfurized alkyl phenols and alkali or alkaline earth metal salts thereof also are useful antioxidants.

Preferred antioxidants include hindered phenols, arylamines. These antioxidants may be used individually by type or in combination with one another. Such additives may be used in an amount of about 0.01 to 5 weight percent, preferably about 0.01 to 1.5 weight percent, more preferably zero to less than 1.5 weight percent, more preferably zero to less than 1 weight percent.

### Detergents

Illustrative detergents useful in this disclosure include, for example, alkali metal detergents, alkaline earth metal detergents, or mixtures of one or more alkali metal detergents and one or more alkaline earth metal detergents. A typical detergent is an anionic material that contains a long chain hydrophobic portion of the molecule and a smaller anionic or oleophobic hydrophilic portion of the molecule. The anionic portion of the detergent is typically derived from an organic acid such as a sulfur-containing acid, carboxylic acid (e.g., salicylic acid), phosphorus-containing acid, phenol, or mixtures thereof. The counterion is typically an alkaline earth or alkali metal. The detergent can be overbased as described herein.

The detergent is preferably a metal salt of an organic or inorganic acid, a metal salt of a phenol, or mixtures thereof. The metal is preferably selected from an alkali metal, an alkaline earth metal, and mixtures thereof. The organic or inorganic acid is selected from an aliphatic organic or inorganic acid, a cycloaliphatic organic or inorganic acid, an aromatic organic or inorganic acid, and mixtures thereof.

The metal is preferably selected from an alkali metal, an alkaline earth metal, and mixtures thereof. More preferably, the metal is selected from calcium (Ca), magnesium (Mg), and mixtures thereof.

The organic acid or inorganic acid is preferably selected from a sulfur-containing acid, a carboxylic acid, a phosphorus-containing acid, and mixtures thereof.

Preferably, the metal salt of an organic or inorganic acid or the metal salt of a phenol comprises calcium phenate, calcium sulfonate, calcium salicylate, magnesium phenate, magnesium sulfonate, magnesium salicylate, an overbased detergent, and mixtures thereof.

Salts that contain a substantially stochiometric amount of the metal are described as neutral salts and have a total base number (TBN, as measured by ASTM D2896) of from 0 to 80. Many compositions are overbased, containing large amounts of a metal base that is achieved by reacting an excess of a metal compound (a metal hydroxide or oxide, for example) with an acidic gas (such as carbon dioxide). Useful detergents can be neutral, mildly overbased, or highly overbased. These detergents can be used in mixtures of neutral, overbased, highly overbased calcium salicylate, sulfonates, phenates and/or magnesium salicylate, sulfonates, phenates. The TBN ranges can vary from low, medium to high TBN products, including as low as 0 to as high as 600. Preferably the TBN delivered by the detergent is between 1 and 20. More preferably between 1 and 12. Mixtures of low, medium, high TBN can be used, along with mixtures of calcium and magnesium metal based detergents, and including sulfonates, phenates, salicylates, and carboxylates. A detergent mixture with a metal ratio of 1, in conjunction of a detergent with a metal ratio of 2, and as high as a detergent with a metal ratio of 5, can be used. Borated detergents can also be used.

Alkaline earth phenates are another useful class of detergent. These detergents can be made by reacting alkaline earth metal hydroxide or oxide (CaO, Ca(OH)₂, BaO, Ba(OH)₂, MgO, Mg(OH)₂, for example) with an alkyl phenol or sulfurized alkylphenol. Useful alkyl groups include straight chain or branched C₁-C₃₀ alkyl groups, preferably, C₄-C₂₀ or mixtures thereof. Examples of suitable phenols include isobutylphenol, 2-ethylhexylphenol, nonylphenol, dodecyl phenol, and the like. It should be noted that starting alkylphenols may contain more than one alkyl substituent that are each independently straight chain or branched and can be used from 0.5 to 6 weight percent. When a non-sulfurized alkylphenol is used, the sulfurized product may be obtained by methods well known in the art. These methods include heating a mixture of alkylphenol and sulfurizing agent (including elemental sulfur, sulfur halides such as sulfur dichloride, and the like) and then reacting the sulfurized phenol with an alkaline earth metal base.

In accordance with this disclosure, metal salts of carboxylic acids are preferred detergents. These carboxylic acid detergents may be prepared by reacting a basic metal compound with at least one carboxylic acid and removing free water from the reaction product. These compounds may be overbased to produce the desired TBN level. Detergents made from salicylic acid are one preferred class of detergents derived from carboxylic acids. Useful salicylates include long chain alkyl salicylates. One useful family of compositions is of the formula

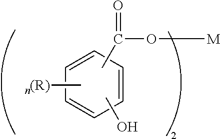

where R is an alkyl group having 1 to about 30 carbon atoms, n is an integer from 1 to 4, and M is an alkaline earth metal. Preferred R groups are alkyl chains of at least C₁₁, preferably C₁₃ or greater. R may be optionally substituted with sub stituents that do not interfere with the detergent's function. M is preferably, calcium, magnesium, barium, or mixtures thereof. More preferably, M is calcium.

Hydrocarbyl-substituted salicylic acids may be prepared from phenols by the Kolbe reaction (see U.S. Pat. No. 3,595,791). The metal salts of the hydrocarbyl-substituted salicylic acids may be prepared by double decomposition of a metal salt in a polar solvent such as water or alcohol.

Alkaline earth metal phosphates are also used as detergents and are known in the art.

Detergents may be simple detergents or what is known as hybrid or complex detergents. The latter detergents can provide the properties of two detergents without the need to blend separate materials. See U.S. Pat. No. 6,034,039.

Preferred detergents include calcium sulfonates, magnesium sulfonates, calcium salicylates, magnesium salicylates, calcium phenates, magnesium phenates, and other related components (including borated detergents), and mixtures thereof. Preferred mixtures of detergents include magnesium sulfonate and calcium salicylate, magnesium sulfonate and calcium sulfonate, magnesium sulfonate and calcium phenate, calcium phenate and calcium salicylate, calcium phenate and calcium sulfonate, calcium phenate and magnesium salicylate, calcium phenate and magnesium phenate. Overbased detergents are also preferred.

The detergent concentration in the lubricating oils of this disclosure can range from about 0.5 to about 6.0 weight percent, preferably about 0.6 to 5.0 weight percent, and more preferably from about 0.8 weight percent to about 4.0 weight percent, based on the total weight of the lubricating oil.

As used herein, the detergent concentrations are given on an “as delivered” basis. Typically, the active detergent is delivered with a process oil. The “as delivered” detergent typically contains from about 20 weight percent to about 100 weight percent, or from about 40 weight percent to about 60 weight percent, of active detergent in the “as delivered” detergent product.

### Inhibitors and Antirust Additives

Antirust additives (or corrosion inhibitors) are additives that protect lubricated metal surfaces against chemical attack by water or other contaminants. A wide variety of these are commercially available.

One type of antirust additive is a polar compound that wets the metal surface preferentially, protecting it with a film of oil. Another type of antirust additive absorbs water by incorporating it in a water-in-oil emulsion so that only the oil touches the metal surface. Yet another type of antirust additive chemically adheres to the metal to produce a non-reactive surface. Examples of suitable additives include zinc dithiophosphates, metal phenolates, basic metal sulfonates, fatty acids and amines. Such additives may be used in an amount of about 0.01 to 5 weight percent, preferably about 0.01 to 1.5 weight percent.

### Antiwear Additives

A metal alkylthiophosphate and more particularly a metal dialkyl dithio phosphate in which the metal constituent is zinc, or zinc dialkyl dithio phosphate (ZDDP) can be a useful component of the lubricating oils of this disclosure. ZDDP can be derived from primary alcohols, secondary alcohols or mixtures thereof. ZDDP compounds generally are of the formula

Zn[SP(S)(OR¹)(OR²)]₂

where R¹ and R² are C₁-C₁₈ alkyl groups, preferably C₂-C₁₂ alkyl groups. These alkyl groups may be straight chain or branched. Alcohols used in the ZDDP can be propanol, 2-propanol, butanol, secondary butanol, pentanols, hexanols such as 4-methyl-2-pentanol, n-hexanol, n-octanol, 2-ethyl hexanol, alkylated phenols, and the like. Mixtures of secondary alcohols or of primary and secondary alcohol can be preferred. Alkyl aryl groups may also be used.

Preferable zinc dithiophosphates which are commercially available include secondary zinc dithiophosphates such as those available from for example, The Lubrizol Corporation under the trade designations “LZ 677A”, “LZ 1095” and “LZ 1371”, from for example Chevron Oronite under the trade designation “OLOA 262” and from for example Afton Chemical under the trade designation “HITEC 7169”.

The ZDDP is typically used in amounts of from about 0.3 weight percent to about 1.5 weight percent, preferably from about 0.4 weight percent to about 1.2 weight percent, more preferably from about 0.5 weight percent to about 1.0 weight percent, and even more preferably from about 0.6 weight percent to about 0.8 weight percent, based on the total weight of the lubricating oil, although more or less can often be used advantageously. Preferably, the ZDDP is a secondary ZDDP and present in an amount of from about 0.6 to 1.0 weight percent of the total weight of the lubricating oil.

### Dispersants

During engine operation, oil-insoluble oxidation byproducts are produced. Dispersants help keep these byproducts in solution, thus diminishing their deposition on metal surfaces. Dispersants used in the formulation of the lubricating oil may be ashless or ash-forming in nature. Preferably, the dispersant is ashless. So called ashless dispersants are organic materials that form substantially no ash upon combustion. For example, non-metal-containing or borated metal-free dispersants are considered ashless. In contrast, metal-containing detergents discussed above form ash upon combustion.

Suitable dispersants typically contain a polar group attached to a relatively high molecular weight hydrocarbon chain. The polar group typically contains at least one element of nitrogen, oxygen, or phosphorus. Typical hydrocarbon chains contain 50 to 400 carbon atoms.

A particularly useful class of dispersants are the (poly)alkenylsuccinic derivatives, typically produced by the reaction of a long chain hydrocarbyl substituted succinic compound, usually a hydrocarbyl substituted succinic anhydride, with a polyhydroxy or polyamino compound. The long chain hydrocarbyl group constituting the oleophilic portion of the molecule which confers solubility in the oil, is normally a polyisobutylene group. Many examples of this type of dispersant are well known commercially and in the literature. Exemplary U.S. patents describing such dispersants are U.S. Pat. Nos. 3,172,892; 3,2145,707; 3,219,666; 3,316,177; 3,341,542; 3,444,170; 3,454,607; 3,541,012; 3,630,904; 3,632,511; 3,787,374 and 4,234,435. Other types of dispersant are described in U.S. Pat. Nos. 3,036,003; 3,200,107; 3,254,025; 3,275,554; 3,438,757; 3,454,555; 3,565,804; 3,413,347; 3,697,574; 3,725,277; 3,725,480; 3,726,882; 4,454,059; 3,329,658; 3,449,250; 3,519,565; 3,666,730; 3,687,849; 3,702,300; 4,100,082; 5,705,458. A further description of dispersants may be found, for example, in European Patent Application No. 471 071, to which reference is made for this purpose.

Hydrocarbyl-substituted succinic acid and hydrocarbyl-substituted succinic anhydride derivatives are useful dispersants. In particular, succinimide, succinate esters, or succinate ester amides prepared by the reaction of a hydrocarbon-substituted succinic acid compound preferably having at least 50 carbon atoms in the hydrocarbon substituent, with at least one equivalent of an alkylene amine are particularly useful.

Succinimides are formed by the condensation reaction between hydrocarbyl substituted succinic anhydrides and amines. Molar ratios can vary depending on the polyamine. For example, the molar ratio of hydrocarbyl substituted succinic anhydride to TEPA can vary from about 1:1 to about 5:1. Representative examples are shown in U.S. Pat. Nos. 3,087,936; 3,172,892; 3,219,666; 3,272,746; 3,322,670; and 3,652,616, 3,948,800; and Canada Patent No. 1,094,044.

Succinate esters are formed by the condensation reaction between hydrocarbyl substituted succinic anhydrides and alcohols or polyols. Molar ratios can vary depending on the alcohol or polyol used. For example, the condensation product of a hydrocarbyl substituted succinic anhydride and pentaerythritol is a useful dispersant.

Succinate ester amides are formed by condensation reaction between hydrocarbyl substituted succinic anhydrides and alkanol amines. For example, suitable alkanol amines include ethoxylated polyalkylpolyamines, propoxylated polyalkylpolyamines and polyalkenylpolyamines such as polyethylene polyamines. One example is propoxylated hexamethylenediamine. Representative examples are shown in U.S. Patent No. 4,426,305.

The molecular weight of the hydrocarbyl substituted succinic anhydrides used in the preceding paragraphs will typically range between 800 and 2,500 or more. The above products can be post-reacted with various reagents such as sulfur, oxygen, formaldehyde, carboxylic acids such as oleic acid. The above products can also be post reacted with boron compounds such as boric acid, borate esters or highly borated dispersants, to form borated dispersants generally having from about 0.1 to about 5 moles of boron per mole of dispersant reaction product.

Mannich base dispersants are made from the reaction of alkylphenols, formaldehyde, and amines. See U.S. Pat. No. 4,767,551, which is incorporated herein by reference. Process aids and catalysts, such as oleic acid and sulfonic acids, can also be part of the reaction mixture. Molecular weights of the alkylphenols range from 800 to 2,500. Representative examples are shown in U.S. Pat. Nos. 3,697,574; 3,703,536; 3,704,308; 3,751,365; 3,756,953; 3,798,165; and 3,803,039.

Typical high molecular weight aliphatic acid modified Mannich condensation products useful in this disclosure can be prepared from high molecular weight alkyl-substituted hydroxyaromatics or HNR2 group-containing reactants.

Hydrocarbyl substituted amine ashless dispersant additives are well known to one skilled in the art; see, for example, U.S. Pat. Nos. 3,275,554; 3,438,757; 3,565,804; 3,755,433, 3,822,209, and 5,084,197.

Preferred dispersants include borated and non-borated succinimides, including those derivatives from mono-succinimides, bis-succinimides, and/or mixtures of mono- and bis-succinimides, wherein the hydrocarbyl succinimide is derived from a hydrocarbylene group such as polyisobutylene having a Mn of from about 500 to about 5000, or from about 1000 to about 3000, or about 1000 to about 2000, or a mixture of such hydrocarbylene groups, often with high terminal vinylic groups. Other preferred dispersants include succinic acid-esters and amides, alkylphenol-polyamine-coupled Mannich adducts, their capped derivatives, and other related components.

Polymethacrylate or polyacrylate derivatives are another class of dispersants. These dispersants are typically prepared by reacting a nitrogen containing monomer and a methacrylic or acrylic acid esters containing 5 -25 carbon atoms in the ester group. Representative examples are shown in U.S. Pat. Nos. 2,100,993, and 6,323,164. Polymethacrylate and polyacrylate dispersants are normally used as multifunctional viscosity modifiers. The lower molecular weight versions can be used as lubricant dispersants or fuel detergents.

Illustrative preferred dispersants useful in this disclosure include those derived from polyalkenyl-substituted mono- or dicarboxylic acid, anhydride or ester, which dispersant has a polyalkenyl moiety with a number average molecular weight of at least 900 and from greater than 1.3 to 1.7, preferably from greater than 1.3 to 1.6, most preferably from greater than 1.3 to 1.5, functional groups (mono- or dicarboxylic acid producing moieties) per polyalkenyl moiety (a medium functionality dispersant). Functionality (F) can be determined according to the following formula:

F=(SAP×Mₙ)/((112,200×A.I.)−(SAP×98))

wherein SAP is the saponification number (i.e., the number of milligrams of KOH consumed in the complete neutralization of the acid groups in one gram of the succinic-containing reaction product, as determined according to ASTM D94); Mn is the number average molecular weight of the starting olefin polymer; and A.I. is the percent active ingredient of the succinic-containing reaction product (the remainder being unreacted olefin polymer, succinic anhydride and diluent).

The polyalkenyl moiety of the dispersant may have a number average molecular weight of at least 900, suitably at least 1500, preferably between 1800 and 3000, such as between 2000 and 2800, more preferably from about 2100 to 2500, and most preferably from about 2200 to about 2400. The molecular weight of a dispersant is generally expressed in terms of the molecular weight of the polyalkenyl moiety. This is because the precise molecular weight range of the dispersant depends on numerous parameters including the type of polymer used to derive the dispersant, the number of functional groups, and the type of nucleophilic group employed.

Polymer molecular weight, specifically Mₙ, can be determined by various known techniques. One convenient method is gel permeation chromatography (GPC), which additionally provides molecular weight distribution information (see W. W. Yau, J. J. Kirkland and D. D. Bly, “Modern Size Exclusion Liquid Chromatography”, John Wiley and Sons, N.Y., 1979). Another useful method for determining molecular weight, particularly for lower molecular weight polymers, is vapor pressure osmometry (e.g., ASTM D3592).

The polyalkenyl moiety in a dispersant preferably has a narrow molecular weight distribution (MWD), also referred to as polydispersity, as determined by the ratio of weight average molecular weight (M_{w}) to number average molecular weight (Mₙ). Polymers having a M_{w}/Mₙ of less than 2.2, preferably less than 2.0, are most desirable. Suitable polymers have a polydispersity of from about 1.5 to 2.1, preferably from about 1.6 to about 1.8.

Suitable polyalkenes employed in the formation of the dispersants include homopolymers, interpolymers or lower molecular weight hydrocarbons. One family of such polymers comprise polymers of ethylene and/or at least one C₃ to C₂ alpha-olefin having the formula H₂C═CHR¹ wherein le is a straight or branched chain alkyl radical comprising 1 to 26 carbon atoms and wherein the polymer contains carbon-to-carbon unsaturation, and a high degree of terminal ethenylidene unsaturation. Preferably, such polymers comprise interpolymers of ethylene and at least one alpha-olefin of the above formula, wherein R¹ is alkyl of from 1 to 18 carbon atoms, and more preferably is alkyl of from 1 to 8 carbon atoms, and more preferably still of from 1 to 2 carbon atoms.

Another useful class of polymers is polymers prepared by cationic polymerization of monomers such as isobutene and styrene. Common polymers from this class include polyisobutenes obtained by polymerization of a C₄ refinery stream having a butene content of 35 to 75% by wt., and an isobutene content of 30 to 60% by wt. A preferred source of monomer for making poly-n-butenes is petroleum feedstreams such as Raffinate II. These feedstocks are disclosed in the art such as in U.S. Pat. No. 4,952,739. A preferred embodiment utilizes polyisobutylene prepared from a pure isobutylene stream or a Raffinate I stream to prepare reactive isobutylene polymers with terminal vinylidene olefins. Polyisobutene polymers that may be employed are generally based on a polymer chain of from 1500 to 3000.

The dispersant(s) are preferably non-polymeric (e.g., mono- or bis-succinimides). Such dispersants can be prepared by conventional processes such as disclosed in U.S. Patent Application Publication No. 2008/0020950, the disclosure of which is incorporated herein by reference.

The dispersant(s) can be borated by conventional means, as generally disclosed in U.S. Pat. Nos. 3,087,936, 3,254,025 and 5,430,105.

Such dispersants may be used in an amount of about 0.01 to 20 weight percent or 0.01 to 10 weight percent, preferably about 0.5 to 8 weight percent, or more preferably 0.5 to 4 weight percent. Or such dispersants may be used in an amount of about 2 to 12 weight percent, preferably about 4 to 10 weight percent, or more preferably 6 to 9 weight percent. On an active ingredient basis, such additives may be used in an amount of about 0.06 to 14 weight percent, preferably about 0.3 to 6 weight percent. The hydrocarbon portion of the dispersant atoms can range from C₆₀ to C₁₀₀₀, or from C₇₀ to C₃₀₀, or from C₇₀ to C₂₀₀. These dispersants may contain both neutral and basic nitrogen, and mixtures of both. Dispersants can be end-capped by borates and/or cyclic carbonates. Nitrogen content in the finished oil can vary from about 200 ppm by weight to about 2000 ppm by weight, preferably from about 200 ppm by weight to about 1200 ppm by weight. Basic nitrogen can vary from about 100 ppm by weight to about 1000 ppm by weight, preferably from about 100 ppm by weight to about 600 ppm by weight.

Dispersants as described herein are beneficially useful with the compositions of this disclosure and substitute for some or all of the surfactants of this disclosure. Further, in one embodiment, preparation of the compositions of this disclosure using one or more dispersants is achieved by combining ingredients of this disclosure, plus optional base stocks and lubricant additives, in a mixture at a temperature above the melting point of such ingredients, particularly that of the one or more M-carboxylates (M═H , metal, two or more metals, mixtures thereof).

As used herein, the dispersant concentrations are given on an “as delivered” basis. Typically, the active dispersant is delivered with a process oil. The “as delivered” dispersant typically contains from about 20 weight percent to about 80 weight percent, or from about 40 weight percent to about 60 weight percent, of active dispersant in the “as delivered” dispersant product.

### Viscosity Modifiers

Viscosity modifiers (also known as viscosity index improvers (VI improvers), and viscosity improvers) can be included in the lubricant compositions of this disclosure.

Viscosity modifiers provide lubricants with high and low temperature operability. These additives impart shear stability at elevated temperatures and acceptable viscosity at low temperatures.

Suitable viscosity modifiers include high molecular weight hydrocarbons, polyesters and viscosity modifier dispersants that function as both a viscosity modifier and a dispersant. Typical molecular weights of these polymers are between about 10,000 to 1,500,000, more typically about 20,000 to 1,200,000, and even more typically between about 50,000 and 1,000,000.

Examples of suitable viscosity modifiers are linear or star-shaped polymers and copolymers of methacrylate, butadiene, olefins, or alkylated styrenes. Polyisobutylene is a commonly used viscosity modifier. Another suitable viscosity modifier is polymethacrylate (copolymers of various chain length alkyl methacrylates, for example), some formulations of which also serve as pour point depressants. Other suitable viscosity modifiers include copolymers of ethylene and propylene, hydrogenated block copolymers of styrene and isoprene, and polyacrylates (copolymers of various chain length acrylates, for example). Specific examples include styrene-isoprene or styrene-butadiene based polymers of 50,000 to 200,000 molecular weight.

Olefin copolymers are commercially available from Chevron Oronite Company LLC under the trade designation “PARATONE®” (such as “PARATONE® 8921” and “PARATONE® 8941”); from Afton Chemical Corporation under the trade designation “HiTEC®” (such as

“HiTEC® 5850B”; and from The Lubrizol Corporation under the trade designation “Lubrizol® 7067C”. Hydrogenated polyisoprene star polymers are commercially available from Infineum International Limited, e.g., under the trade designation “SV200” and “SV600”. Hydrogenated diene-styrene block copolymers are commercially available from Infineum International Limited, e.g., under the trade designation “SV 50”.

The polymethacrylate or polyacrylate polymers can be linear polymers which are available from Evnoik Industries under the trade designation “Viscoplex®” (e.g., Viscoplex 6-954) or star polymers which are available from Lubrizol Corporation under the trade designation Asteric™ (e.g., Lubrizol 87708 and Lubrizol 87725).

Illustrative vinyl aromatic-containing polymers useful in this disclosure may be derived predominantly from vinyl aromatic hydrocarbon monomer. Illustrative vinyl aromatic-containing copolymers useful in this disclosure may be represented by the following general formula:

A—B

wherein A is a polymeric block derived predominantly from vinyl aromatic hydrocarbon monomer, and B is a polymeric block derived predominantly from conjugated diene monomer.

In an embodiment of this disclosure, the viscosity modifiers may be used in an amount of less than about 10 weight percent, preferably less than about 7 weight percent, more preferably less than about 4 weight percent, and in certain instances, may be used at less than 2 weight percent, preferably less than about 1 weight percent, and more preferably less than about 0.5 weight percent, based on the total weight of the formulated oil or lubricating engine oil. Viscosity modifiers are typically added as concentrates, in large amounts of diluent oil.

As used herein, the viscosity modifier concentrations are given on an “as delivered” basis. Typically, the active polymer is delivered with a diluent oil. The “as delivered” viscosity modifier typically contains from 20 weight percent to 75 weight percent of an active polymer for polymethacrylate or polyacrylate polymers, or from 8 weight percent to 20 weight percent of an active polymer for olefin copolymers, hydrogenated polyisoprene star polymers, or hydrogenated diene-styrene block copolymers, in the “as delivered” polymer concentrate.

### Pour Point Depressants (PPDs)

Conventional pour point depressants (also known as lube oil flow improvers) may be added to the compositions of the present disclosure if desired. These pour point depressant may be added to lubricating compositions of the present disclosure to lower the minimum temperature at which the fluid will flow or can be poured. Examples of suitable pour point depressants include polymethacrylates, polyacrylates, polyarylamides, condensation products of haloparaffin waxes and aromatic compounds, vinyl carboxylate polymers, and terpolymers of dialkylfumarates, vinyl esters of fatty acids and allyl vinyl ethers. U.S. Pat. Nos. 1,815,022; 2,015,748; 2,191,498; 2,387,501; 2,655, 479; 2,666,746; 2,721,877; 2,721,878; and 3,250,715 describe useful pour point depressants and/or the preparation thereof. Such additives may be used in an amount of about 0.01 to 5 weight percent, preferably about 0.01 to 1.5 weight percent.

### Seal Compatibility Agents

Seal compatibility agents help to swell elastomeric seals by causing a chemical reaction in the fluid or physical change in the elastomer. Suitable seal compatibility agents for lubricating oils include organic phosphates, aromatic esters, aromatic hydrocarbons, esters (butylbenzyl phthalate, for example), and polybutenyl succinic anhydride. Such additives may be used in an amount of about 0.01 to 3 weight percent, preferably about 0.01 to 2 weight percent.

### Antifoam Agents

Anti-foam agents may advantageously be added to lubricant compositions. These agents retard the formation of stable foams. Silicones and organic polymers are typical anti-foam agents. For example, polysiloxanes, such as silicon oil or polydimethyl siloxane, provide antifoam properties. Anti-foam agents are commercially available and may be used in conventional minor amounts along with other additives such as demulsifiers; usually the amount of these additives combined is less than 1 weight percent and often less than 0.1 weight percent.

When lubricating oil compositions contain one or more of the additives discussed above, the additive(s) are blended into the composition in an amount sufficient for it to perform its intended function. Typical amounts of such additives useful in the present disclosure are shown in Table 1 below.

It is noted that many of the additives are shipped from the additive manufacturer as a concentrate, containing one or more additives together, with a certain amount of base oil diluents. Accordingly, the weight amounts in the table below, as well as other amounts mentioned herein, are directed to the amount of active ingredient (that is the non-diluent portion of the ingredient). The weight percent (wt %) indicated below is based on the total weight of the lubricating oil composition.

TABLE 1
Typical Amounts of Other Lubricating Oil Components

| | Approximate | Approximate |
|---|---|---|
| Compound | wt % (Useful) | wt % (Preferred) |
| Dispersant | 0.1-20 | 0.1-8 |
| Detergent | 0.1-20 | 0.1-8 |
| Friction Modifier | 0.01-5 | 0.01-1.5 |
| Antioxidant | 0.1-5 | 0.1-1.5 |
| Pour Point Depressant (PPD) | 0.0-5 | 0.01-1.5 |
| Anti-foam Agent | 0.001-3 | 0.001-0.15 |
| Viscosity Modifier (solid polymer | 0.1-2 | 0.1-1 |
| basis) | | |
| Antiwear | 0.2-3 | 0.5-1 |
| Inhibitor and Antirust | 0.01-5 | 0.01-1.5 |

The foregoing additives are all commercially available materials. These additives may be added independently but are usually precombined in packages which can be obtained from suppliers of lubricant oil additives. Additive packages with a variety of ingredients, proportions and characteristics are available and selection of the appropriate package will take the requisite use of the ultimate composition into account.

The following non-limiting examples are provided to illustrate the disclosure.

### EXAMPLES

Microencapsulated lubricating oil additives were prepared as described herein. Formulations were prepared as described herein. All of the ingredients used herein are commercially available. PCMO (passenger car motor oil) formulations were prepared as described herein.

The lubricating oil additives used as the core material in the microcapsules were friction modifiers including soluble molybdenum friction modifiers and organic friction modifiers.

The polymers used as the encapsulating material in in the microcapsules were polyvinyl pyrrolidone (PVP), hydroxypropyl cellulose (HPC), ethyl cellulose (EC), and polyurea.

A tribometer, a High Frequency Reciprocating Rig (HFRR), was used for measuring friction response. Test configuration was an oscillating ball-on-disk, with an applied load and heating, and with ball and disk hardware immersed in oil. Friction was measured with a load cell, and film thickness between the rubbing surfaces of the ball and disk were measured electrically.

Friction performance was evaluated as described above using a HFRR test. The HFRR is commercially available from PCS Industries. The test equipment and procedure are similar to the ASTM D6079 method. The HFRR test conditions were as follows: temperature 100° C.; test duration 2 hours; stroke length 1 mm; frequency 10 Hz; and load 400 grams. Wear was measured on the disk. The ball is 6 mm diameter ANSI E-52100 steel, Rockwell C hardness of 58-66. The disc is AISI E-52100 steel, Vickers HV30 hardness of ˜200.

Friction and percent film thickness were measured in real-time during the test. At the end of each test, the disk was removed and wear depth was measured. A mechanical stylus profile was used to measure the depth of the wear scar along three lines perpendicular to the long axis of the wear scar at three positions along the length of the scar. Friction performance was represented as the depth of the scars at the deepest point along these three lines.

### Preparation of Microencapsulated Lubricating Oil Additive—Ethyl Cellulose (EC) Polymeric Matrix Microencapsulation and Organic Friction Modifier Core

An emulsion-based solvent evaporation technique was used to prepare matrix particles of encapsulated organic friction modifier in an ethyl cellulose matrix. 2 g of friction modifier was dissolved into 60 g of methanol with 8 g of 4 cP ethyl cellulose. This solution was emulsified into 80 g of polyalphaolefin with 0.2 g of a dispersant. Emulsification was achieved with a rotor-stator mixer at 8,000 rpm for 10 seconds. The emulsion was recirculated through a high pressure homogenizer, Avestin Emulsiflex C-5, for 6 hours at 22,000 psi.

### Preparation of Microencapsulated Lubricating Oil Additive—Polyvinyl Pyrrolidone (PVP) Polymeric Matrix Microencapsulation and Organic Friction Modifier Core

An emulsion-based solvent evaporation technique was used to prepare matrix particles of encapsulated organic friction modifier in an PVP matrix. 2 g of friction modifier was dissolved into 30 g of acetonitrile with 8 g of K-25 PVP. This solution was emulsified into 80 g of polyalphaolefin with 0.1 g of a dispersant. Emulsification was achieved with a rotor-stator mixer at 8,000 rpm for 10 seconds. The emulsion was through a high pressure homogenizer, Avestin Emulsiflex C-5, seven times at 20,000 psi. An additional 0.1 g of dispersant was added to the mixture, followed by an additional seven passes through the homogenizer.

### Preparation of Microencapsulated Lubricating Oil Additive—Polyvinyl Pyrrolidone (PVP) Polymeric Matrix Microencapsulation and Soluble Molybdenum Friction Modifier Core

Spray drying was used to prepare molybdenum friction modifier encapsulated in a PVP matrix. 7.5 g of friction modifier and 17.5 g of PVP were dissolved into 475 g of dichloromethane. The homogeneous solution was spray dried with a Pro-C-epT 4M8 laboratory spray drier with a 0.15 mm air-atomized nozzle. The inlet temperature was set to 35° C. and the mixture pumped into the dryer at 3.5 g/min. The resulting powder was collected in a cyclone.

### Preparation of Microencapsulated Lubricating Oil Additive—Hydroxypropyl Cellulose (HPC) Polymeric Matrix Microencapsulation and Organic Friction Modifier Core

Spray drying was used to prepare organic friction modifier encapsulated in a HPC matrix. 7.5 g of friction modifier and 17.5 g of HPC were dissolved into 1175 g of dichloromethane. The homogeneous solution was spray dried with a Pro-C-epT 4M8 laboratory spray drier with a 0.15 mm air-atomized nozzle. The inlet temperature was set to 35° C. and the mixture pumped into the dryer at 4.2 g/min. The resulting powder was collected in a cyclone.

### Preparation of Microencapsulated Lubricating Oil Additive—Hydroxypropyl Cellulose (HPC) Polymeric Matrix Microencapsulation and Soluble Molybdenum Friction Modifier Core

Spray drying was used to prepare molybdenum friction modifier encapsulated in a HPC matrix. 7.5 g of friction modifier and 17.5 g of HPC were dissolved into 1075 g of dichloromethane. The homogeneous solution was spray dried with a Pro-C-epT 4M8 laboratory spray drier with a 0.15 mm air-atomized nozzle. The inlet temperature was set to 35° C. and the mixture pumped into the dryer at 5.3 g/min. The resulting powder was collected in a cyclone.

### Preparation of Microencapsulated Lubricating Oil Additive—Polyurea Core Shell Microencapsulation and Organic Friction Modifier Core

Interfacial polymerization was used to prepare a core-shell formulation of an organic friction modifier in a polyurea shell. A core material solution was prepared with 10 g of organic friction modifier, 10 g of polyalphaolefin base oil, and 1 g of PAPI 94, a polymethylene polyphenylisocyanate also containing methylene diphenyl diisocyanate. This homogeneous core mixture was emulsified into 250 mL of deionized water containing 400 mg of Tween 80. Emulsification was carried out with a rotor-stator mixer at 15,000 rpm for 1 minute. Stirring was then reduced to 200 rpm with an overhead stirrer, followed by addition of a 50 mL aqueous solution containing 0.5 g of diethylene triamine. After 2 hours are room temperature, the capsule suspension was washed twice with 250 mL of deionized water and 0.1% Brij 30 surfactant, followed by lyophilization to produce a dry powder.

### Preparation of Microencapsulated Lubricating Oil Additive—Polyurea Core Shell Microencapsulation and Soluble Molybdenum Friction Modifier Core

Interfacial polymerization was used to prepare a core-shell formulation of a soluble molybdenum friction modifier in a polyurea shell. A core material solution was prepared with 20 g of soluble molybdenum friction modifier, 20 g of dichloromethane, and 2 g of PAPI 94, a polymethylene polyphenylisocyanate also containing methylene diphenyl diisocyanate. This homogeneous core mixture was emulsified into 500 mL of deionized water containing 120 mg of Tween 80. Emulsification was carried out with a rotor-stator mixer at 15,000 rpm for 1 minute. Stirring was then reduced to 200 rpm with an overhead stirrer, followed by addition of a 20 mL aqueous solution containing 2 g of diethylene triamine. After 2 hours are room temperature, the capsule suspension was washed twice with 400 mL of deionized water and 0.1% Brij 30 surfactant, followed by lyophilization to produce a dry powder.

### Testing of Microencapsulated Lubricating Oil Additives in Lubricants

For testing, the microencapsulated lubricating oil additive samples were blended into a lubricating oil base stock (i.e., selected from API Group I, Group II, Group III, Group IV, and Group V oils, and mixtures thereof). The treat rate of the capsules plus additives is calculated to result in the same additive concentration range of the non-encapsulated additives as given in Table 1.

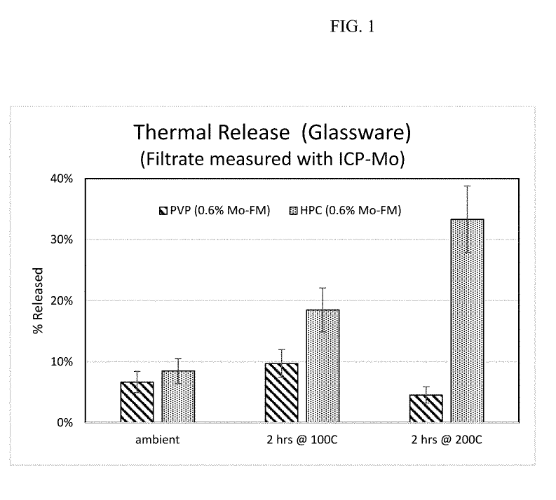

FIG. 1 graphically depicts thermal stability testing results of polymeric matrix microparticles containing a soluble molybdenum friction modifier. The filtrate was measured with inductively coupled plasma mass spectrometry (ICP-Mo). Polymeric matrix microcapsules of polyvinyl pyrrolidone (PVP) and hydroxypropyl cellulose (HPC) demonstrate acceptable thermal stability for in-engine applications, for the soluble molybdenum friction modifier. In these polymeric matrix microcapsules, the release rates of the active lubricating oil additives into the bulk fluid is low. FIG. 1 shows a comparison of a Mo friction modifier released from polyvinylpyrrolidone (PVP) and hydroxypropylcellulose (HPC) matrix capsules after glassware thermal aging.

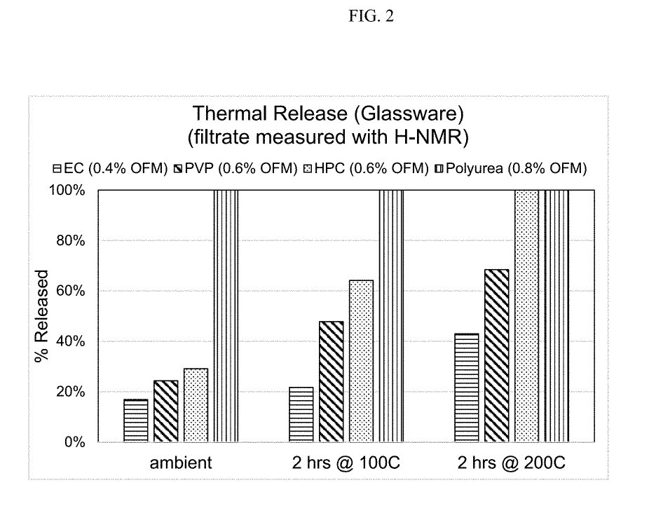

FIG. 2 graphically depicts thermal stability testing results of polymeric matrix microparticles containing an organic friction modifier. FIG. 2 also graphically depicts thermal stability of polyurea core shell microparticles containing an organic friction modifier. The filtrate was measured with proton nuclear magnetic resonance (H-NMR). Polymeric matrix microcapsules of polyvinyl pyrrolidone (PVP), hydroxypropyl cellulose (HPC), and ethyl cellulose (EC) demonstrate acceptable thermal stability for in-engine applications, for the organic friction modifier. In these polymeric matrix microcapsules, the release rates of the active lubricating oil additives into the bulk fluid is low. The high release rates from the organic friction modifier encapsulated in the hard-sphere polyurea microcapsule is attributed to low shear stability during stirring and mixing. FIG. 2 shows a comparison of an organic friction modifier released from ethyl cellulose (EC), polyvinylpyrrolidone (PVP), hydroxypropylcellulose (HPC) and polyurea matrix capsules after glassware thermal aging.

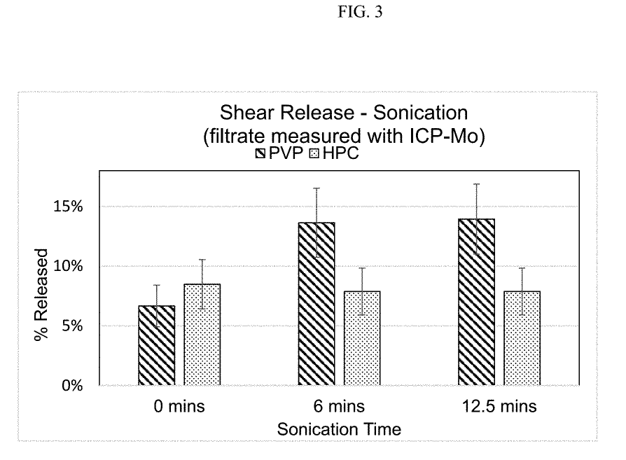

FIG. 3 graphically depicts shear stability testing results of polymeric matrix microparticles containing a soluble molybdenum friction modifier. The filtrate was measured with inductively coupled plasma mass spectrometry (ICP-Mo). Polymeric matrix microcapsules of polyvinyl pyrrolidone (PVP) and hydroxypropyl cellulose (HPC) demonstrate exceptional bulk fluid shear stability for in-engine applications, for the soluble molybdenum friction modifier. In these polymeric matrix microcapsules, the release rates of the active lubricating oil additives into the bulk fluid is low. FIG. 3 shows a comparison of a Mo friction modifier released from polyvinylpyrrolidone (PVP) and hydroxypropylcellulose (HPC) matrix capsules after being subjected to sonication.

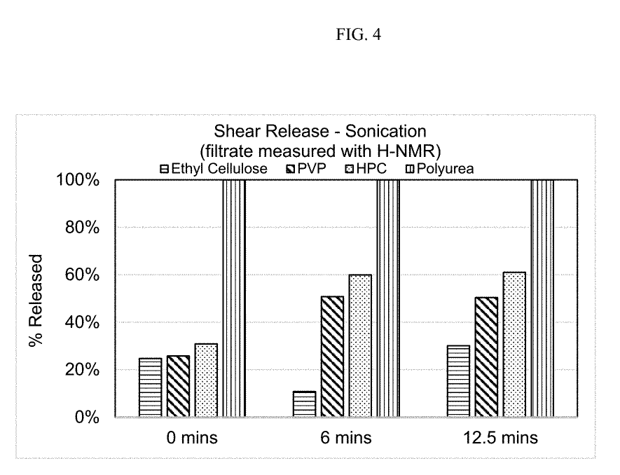

FIG. 4 graphically depicts shear stability testing results of polymeric matrix microparticles containing an organic friction modifier. FIG. 4 also graphically depicts shear stability of polyurea core shell microparticles containing an organic friction modifier. The filtrate was measured with proton nuclear magnetic resonance (H-NMR). Polymeric matrix microcapsules of polyvinyl pyrrolidone (PVP), hydroxypropyl cellulose (HPC), and ethyl cellulose (EC) demonstrate exceptional bulk fluid shear stability for in-engine applications, for the organic friction modifier. In these polymeric matrix microcapsules, the release rates of the active lubricating oil additives into the bulk fluid is very low. The high release rates from the organic friction modifier encapsulated in the hard-sphere polyurea microcapsule is attributed to its poor mechanical stability. FIG. 4 shows a comparison of an organic friction modifier released from polyvinylpyrrolidone (PVP) and hydroxypropylcellulose (HPC) matrix capsules measured using H-NMR after being subjected to sonication.

Controlled release friction performance was demonstrated for the polymeric matrix of polyvinyl pyrrolidone (PVP), hydroxypropyl cellulose (HPC) and ethyl cellulose (EC) containing an organic friction modifier core or a soluble molybdenum friction modifier core.

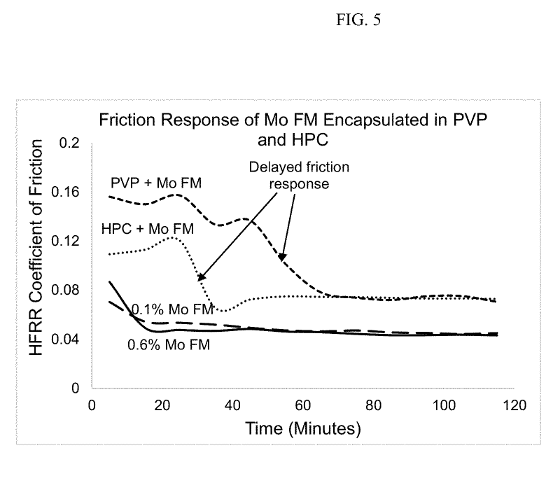

FIG. 5 graphically depicts HFRR testing results (i.e., friction response) of a soluble molybdenum friction modifier in bulk form as compared to encapsulated in hydroxypropyl cellulose (HPC) polymeric matrix or polyvinyl pyrrolidone (PVP) polymeric matrix. Delayed time to achieve minimum friction performance for hydroxypropyl cellulose (HPC) and polyvinyl pyrrolidone (PVP) capsules supports controlled release friction performance. The hydroxypropyl cellulose (HPC) capsule achieved minimum friction before the polyvinyl pyrrolidone (PVP) capsule which is consistent with thermal stability. FIG. 5 shows a friction response at 100° C. measured in a PCS Instruments HFRR test showing delayed response of a molybdenum friction modifier encapsulated in a PVP and a HPC polymer matrix.

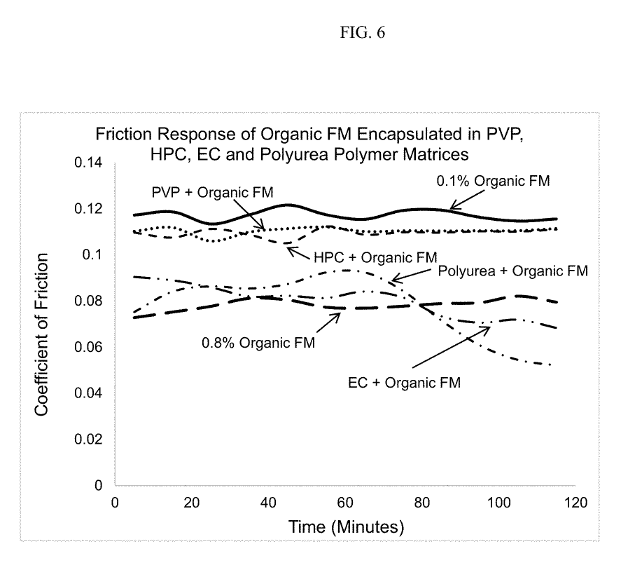

FIG. 6 graphically depicts HFRR testing results (i.e., friction response) of an organic friction modifier in bulk form as compared to encapsulated in hydroxypropyl cellulose (HPC) polymeric matrix, polyvinyl pyrrolidone (PVP) polymeric matrix, ethyl cellulose (EC) polymeric matrix, or polyurea core shell capsule. Delayed time to achieve minimum friction performance for ethyl cellulose (EC) and polyurea capsules supports controlled release friction performance. The added friction benefit for ethyl cellulose (EC) and polyurea capsules containing an organic friction modifier core over bulk soluble molybdenum friction modifier was observed. This is attributed to friction reduction provided by polymer materials. FIG. 6 shows a friction response at 100° C. measured in a PCS Instruments HFRR test showing response of an organic friction modifier encapsulated in PVP, HPC, EC and polyurea polymer matrices.

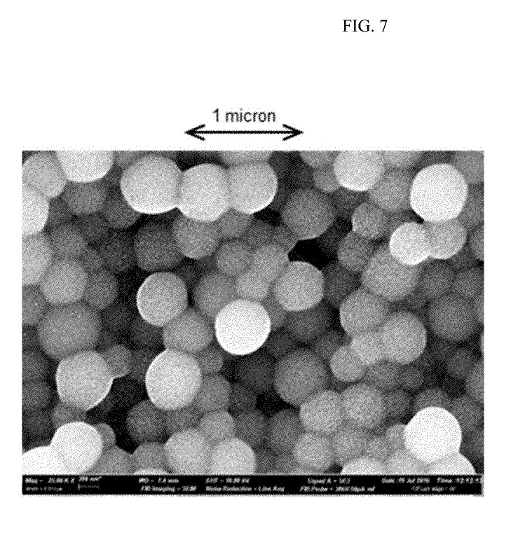

FIG. 7 is a SEM image showing size and morphology of an organic friction modifier encapsulated within a PVP polymer matrix.

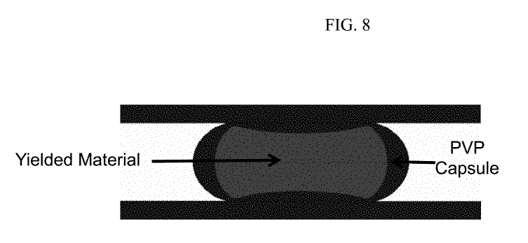

FIG. 8 shows results from a finite element analysis showing deformation of PVP capsules as they pass through a highly loaded lubricated contact.

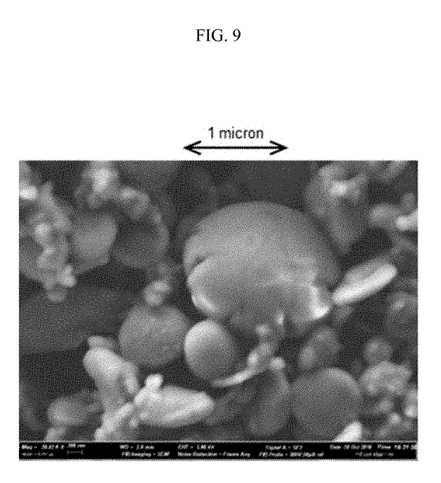

FIG. 9 is a SEM image showing deformed and ruptured PVP/organic friction modifier capsules after being run in a rolling element bearing test for 20 hours. PCT and EP Clauses:

1. A method for extending performance of a lubricating oil in an engine or other mechanical component lubricated with the lubricating oil by using as the lubricating oil a formulated oil, said formulated oil having a composition comprising a lubricating oil base stock as a major component; and at least one microencapsulated lubricating oil additive, as a minor component; wherein the at least one microencapsulated lubricating oil additive comprises an encapsulating material and a core material encapsulated by the encapsulating material; and wherein the encapsulating material comprises a polymeric matrix and the core material comprises at least one lubricating oil additive.

2. A method of improving solubility, compatibility and/or dispersion of lubricating oil additives in a lubricating oil base stock, said method comprising:

providing a lubricating oil base stock; and

blending at least one microencapsulated lubricating oil additive in the lubricating oil base stock; wherein the at least one microencapsulated lubricating oil additive comprises an encapsulating material and a core material encapsulated by the encapsulating material; and wherein the encapsulating material comprises a polymeric matrix and the core material comprises at least one lubricating oil additive.

3. A method for controlling release of a lubricating oil additive into a lubricating oil by using as the lubricating oil a formulated oil, said formulated oil having a composition comprising a lubricating oil base stock as a major component; and at least one microencapsulated lubricating oil additive, as a minor component; wherein the at least one microencapsulated lubricating oil additive comprises an encapsulating material and a core material encapsulated by the encapsulating material; and wherein the encapsulating material comprises a polymeric matrix and the core material comprises at least one lubricating oil additive.

4. The method of clauses 1-3 wherein the lubricating oil base stock comprises a Group I, Group II, Group III, Group IV or Group V base oil.

5. The method of clauses 1-3 wherein the lubricating oil additive is selected from the group consisting of a friction modifier, antiwear additive, viscosity modifier, antioxidant, detergent, dispersant, pour point depressant, corrosion inhibitor, metal deactivator, seal compatibility additive, anti-foam agent, inhibitor, and anti-rust additive.

6. The method of clauses 1-3 wherein the lubricating oil additive is selected from the group consisting of a friction modifier, antioxidant, detergent, corrosion inhibitor, and rust inhibitor.

7. The method of clauses 1-3 wherein the polymeric matrix comprises a polymer selected from the group consisting of polymethyl methacrylate (PMMA), polyvinyl pyrrolidone (PVP), polyvinyl alcohol (PVOH), hydroxypropyl cellulose (HPC), ethyl cellulose (EC), ethyl cyanoacrylate, polycyanoacrylate, and poly(alpha-methyl styrene).

8. The method of clauses 1-3 wherein the polymeric matrix comprises a polymer selected from the group consisting of polyvinyl pyrrolidone (PVP), hydroxypropyl cellulose (HPC), and ethyl cellulose (EC).

9. The method of clauses 1-3 wherein the polymeric matrix comprises polyvinyl pyrrolidone (PVP) or ethyl cellulose (EC).

10. The method of clauses 1-3 wherein the at least one microencapsulated lubricating oil additive comprises particles having an average particle size from 100 nanometers (nm) to 1 micrometer (μm).

11. The method of clauses 1-3 wherein the formulated oil further comprises at least one lubricating oil additive that is not microencapsulated.

12. The method of clauses 1-3 wherein the at least one microencapsulated lubricating oil additive is present in an amount of from 0.001 weight percent to 20 weight percent, based on the total weight of the formulated oil.

13. The method of clauses 1-3 wherein the lubricating oil base stock is present in an amount of from 6 weight percent to 95 weight percent, based on the total weight of the formulated oil.

14. A lubricating oil having a composition comprising a lubricating oil base stock as a major component; and at least one microencapsulated lubricating oil additive, as a minor component; wherein the at least one microencapsulated lubricating oil additive comprises an encapsulating material and a core material encapsulated by the encapsulating material; and wherein the encapsulating material comprises a polymeric matrix and the core material comprises at least one lubricating oil additive.

15. A microcapsule comprising:

an encapsulating material comprising a polymeric matrix; and

a core material comprising at least one lubricating oil additive;

wherein the microcapsule has an average particle size d₅₀ from 100 nanometers (nm) to 1 micrometer (μm).

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

When numerical lower limits and numerical upper limits are listed herein, ranges from any lower limit to any upper limit are contemplated. While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the present disclosure, including all features which would be treated as equivalents thereof by those skilled in the art to which the disclosure pertains.

The present disclosure has been described above with reference to numerous embodiments and specific examples. Many variations will suggest themselves to those skilled in this art in light of the above detailed description. All such obvious variations are within the full intended scope of the appended claims.

1. A method for extending performance of a lubricating oil in an engine or other mechanical component lubricated with the lubricating oil by using as the lubricating oil a formulated oil, said formulated oil having a composition comprising a lubricating oil base stock as a major component; and at least one microencapsulated lubricating oil additive, as a minor component; wherein the at least one microencapsulated lubricating oil additive comprises an encapsulating material and a core material encapsulated by the encapsulating material; and wherein the encapsulating material comprises a polymeric matrix and the core material comprises at least one lubricating oil additive.

2. The method of claim 1 wherein duration of performance of the lubricating oil in an engine or other mechanical component lubricated with the lubricating oil is extended as compared to duration of performance of a lubricating oil containing a minor component other than the at least one microencapsulated lubricating oil additive.

3. The method of claim 1 wherein the lubricating oil base stock comprises a Group I, Group II, Group III, Group IV or Group V base oil.

4. The method of claim 1 wherein the lubricating oil additive is selected from the group consisting of a friction modifier, antiwear additive, viscosity modifier, antioxidant, detergent, dispersant, pour point depressant, corrosion inhibitor, metal deactivator, seal compatibility additive, anti-foam agent, inhibitor, and anti-rust additive.

5. The method of claim 1 wherein the lubricating oil additive is selected from the group consisting of a friction modifier, antioxidant, detergent, corrosion inhibitor, and rust inhibitor.

6. The method of claim 1 wherein the polymeric matrix comprises a polymer selected from the group consisting of polymethyl methacrylate (PMMA), polyvinyl pyrrolidone (PVP), polyvinyl alcohol (PVOH), hydroxypropyl cellulose (HPC), ethyl cellulose (EC), ethyl cyanoacrylate, polycyanoacrylate, and poly(alpha-methyl styrene).

7. The method of claim 1 wherein the polymeric matrix comprises a polymer selected from the group consisting of polyvinyl pyrrolidone (PVP), hydroxypropyl cellulose (HPC), and ethyl cellulose (EC).

8. The method of claim 1 wherein the polymeric matrix comprises polyvinyl pyrrolidone (PVP) or ethyl cellulose (EC).

9. The method of claim 1 wherein the polymeric matrix is formed by solvent evaporation.

10. The method of claim 1 wherein the at least one microencapsulated lubricating oil additive comprises particles having an average particle size from about 100 nanometers (nm) to about 1 micrometer (μm).

11. The method of claim 1 wherein the core material comprising at least one lubricating oil additive is controllably released into the lubricating oil by thermal degradation, chemical degradation or mechanical degradation of the polymeric matrix.

12. The method of claim 1 wherein the core material comprising at least one lubricating oil additive is released into the lubricating oil by diffusion.

13. The method of claim 1 wherein the formulated oil further comprises at least one lubricating oil additive that is not microencapsulated.

14. The method of claim 1 wherein the at least one microencapsulated lubricating oil additive is present in an amount of from about 0.001 weight percent to about 20 weight percent, based on the total weight of the formulated oil.

15. The method of claim 1 wherein the lubricating oil base stock is present in an amount of from about 6 weight percent to about 95 weight percent, based on the total weight of the formulated oil.

16. The method of claim 1 wherein the mechanical component is an internal combustion engine, a power train, a driveline, a transmission, a gear, a gear train, a gear set, a compressor, a pump, a hydraulic system, a bearing, a bushing, or a turbine

17. The method of claim 1 wherein the mechanical component is a piston, a piston ring, a cylinder liner, a cylinder, a cam, a tappet, a lifter, a gear, a valve, or a bearing including a journal, a roller, a tapered, a needle, or a ball bearing.

18. A method of improving solubility, compatibility and/or dispersion of lubricating oil additives in a lubricating oil base stock, said method comprising:
providing a lubricating oil base stock; and
blending at least one microencapsulated lubricating oil additive in the lubricating oil base stock;
wherein the at least one microencapsulated lubricating oil additive comprises an encapsulating material and a core material encapsulated by the encapsulating material; and
wherein the encapsulating material comprises a polymeric matrix and the core material comprises at least one lubricating oil additive.

19. A method for controlling release of a lubricating oil additive into a lubricating oil by using as the lubricating oil a formulated oil, said formulated oil having a composition comprising a lubricating oil base stock as a major component; and at least one microencapsulated lubricating oil additive, as a minor component; wherein the at least one microencapsulated lubricating oil additive comprises an encapsulating material and a core material encapsulated by the encapsulating material; and wherein the encapsulating material comprises a polymeric matrix and the core material comprises at least one lubricating oil additive.

20. A lubricating oil having a composition comprising a lubricating oil base stock as a major component; and at least one microencapsulated lubricating oil additive, as a minor component; wherein the at least one microencapsulated lubricating oil additive comprises an encapsulating material and a core material encapsulated by the encapsulating material; and wherein the encapsulating material comprises a polymeric matrix and the core material comprises at least one lubricating oil additive.

21. The lubricating oil of claim 19 wherein the lubricating oil base stock comprises a Group I, Group II, Group III, Group IV or Group V base oil.

22. The lubricating oil of claim 19 wherein the lubricating oil additive is selected from the group consisting of a friction modifier, antiwear additive, viscosity modifier, antioxidant, detergent, dispersant, pour point depressant, corrosion inhibitor, metal deactivator, seal compatibility additive, anti-foam agent, inhibitor, and anti-rust additive.

23. The lubricating oil of claim 19 wherein the lubricating oil additive is selected from the group consisting of a friction modifier, antioxidant, detergent, corrosion inhibitor, and rust inhibitor.

24. The lubricating oil of claim 19 wherein the polymeric matrix comprises a polymer selected from the group consisting of polymethyl methacrylate (PMMA), polyvinyl pyrrolidone (PVP), polyvinyl alcohol (PVOH), hydroxypropyl cellulose (HPC), ethyl cellulose (EC), ethyl cyanoacrylate, polycyanoacrylate, and poly(alpha-methyl styrene).

25. The lubricating oil of claim 19 wherein the polymeric matrix comprises a polymer selected from the group consisting of polyvinyl pyrrolidone (PVP), hydroxypropyl cellulose (HPC), and ethyl cellulose (EC).

26. The lubricating oil of claim 19 wherein the polymeric matrix comprises polyvinyl pyrrolidone (PVP) or ethyl cellulose (EC).

27. The lubricating oil of claim 19 wherein the polymeric matrix is formed by solvent evaporation.

28. The lubricating oil of claim 19 wherein the at least one microencapsulated lubricating oil additive comprises particles having an average particle size from about 100 nanometers (nm) to about 1 micrometer (μm).

29. The lubricating oil of claim 19 wherein the core material comprising at least one lubricating oil additive is controllably released into the lubricating oil by thermal degradation, chemical degradation or mechanical degradation of the encapsulating material comprising the polymeric matrix.

30. The lubricating oil of claim 19 wherein the core material comprising at least one lubricating oil additive is released into the lubricating oil by diffusion.

31. The lubricating oil of claim 19 wherein the formulated oil further comprises at least one lubricating oil additive that is not microencapsulated.

32. The lubricating oil of claim 19 wherein the at least one microencapsulated lubricating oil additive is present in an amount of from about 0.001 weight percent to about 20 weight percent, based on the total weight of the formulated oil.

33. The lubricating oil of claim 19 wherein the lubricating oil base stock is present in an amount of from about 6 weight percent to about 95 weight percent, based on the total weight of the formulated oil.

34. The lubricating oil of claim 19 which is a passenger vehicle engine oil (PVEO).

35. The lubricating oil of claim 19 which is an engine lubricating oil or a mechanical component lubricating oil.

36. A microcapsule comprising:
an encapsulating material comprising a polymeric matrix; and
a core material comprising at least one lubricating oil additive;
wherein the microcapsule has an average particle size d₅₀ from about 100 nanometers (nm) to about 1 micrometer (μm).
